(19) United States
(12) Patent Application Publication
(10) Pub. No.: US 2026/0237316 A1
(43) Pub. Date: Aug. 13, 2026

(54) SYSTEM AND METHOD FOR REMOTE NON-DESTRUCTIVE TESTING AND TRAINING

(71) Applicant: Glenn Malbrue, Carencro, LA (US)

(72) Inventor: Glenn Malbrue, Carencro, LA (US)

(21) Appl. No.: 19/633,534

(22) Filed: Mar. 30, 2026

Related U.S. Application Data
(63) Continuation-in-part of application No. 18/491,117, filed on Oct. 20, 2023.

(51) Int. Cl. G09B 5/02

(52) U.S. Cl. CPC G09B 5/02

(57) ABSTRACT

A remote non-destructive practical applications testing and training system, method and platform is disclosed. The system comprises an administrator module, test module, test viewer module, sample manager module, and live viewer module. The administrator module allows for the addition and editing of candidate information within the system. The test module generates tests for candidates using each candidate's candidate ID, testing profile, and test samples stored within the system. The test module also stores the tests and test results in a manner that allows candidates and trainers to review the tests after the tests are submitted. The sample manager module allows for test samples to be added to or edited on the system. The live viewer module allows users to conduct remote training with augmented reality overlaid on video communications to enhance training.

### FIELD OF THE DISCLOSURE

The present invention relates to remote non-destructive testing (NDT) training systems and methods that provide hands-on practical experience through digital platforms with real-time communication capabilities.

### BACKGROUND

The modern world relies on safe and reliable infrastructure and systems to provide all the comforts and tools of modern life, including power generation facilities, transportation networks, storage tanks, pipelines, and structural materials, among many others. It is imperative that such infrastructure and systems remain operational on a consistent and long-term basis with minimal disruption to their operation. Failures in critical infrastructure can result in catastrophic consequences, including environmental damage, economic losses, and threats to human safety. Thus, proper and timely maintenance must be performed to ensure the integrity and longevity of these essential systems. However, maintenance activities can be disruptive to operations and may require significant downtime that affects productivity and service delivery. There may also be situations where maintenance is performed unnecessarily, wasting valuable resources including money, time, and personnel that could be allocated more efficiently elsewhere.

One way to ensure that maintenance is necessary and that disruption is minimized is to perform non-destructive testing (NDT), which allows for the evaluation of materials and components without causing damage to the items being tested. NDT encompasses a variety of testing methods including ultrasonic testing, radiographic testing, magnetic particle testing, liquid penetrant testing, and visual inspection, each requiring specialized knowledge and skills. These testing methods are performed by technicians who must be certified to conduct specific non-destructive tests according to industry standards established by organizations such as the American Society of Non-Destructive Testing (ASNT). To achieve certification, technicians must complete formal classroom training covering theoretical principles and then obtain substantial on-the-job or hands-on training experience working with actual testing equipment and samples. The certification process culminates in rigorous examinations that assess both theoretical knowledge and practical competency in performing NDT procedures accurately and consistently. For example, a technician seeking certification in ultrasonic thickness testing must demonstrate proficiency in equipment calibration, proper transducer placement, accurate measurement interpretation, and flaw detection techniques before being authorized to perform inspections independently.

Current approaches to NDT training present significant challenges that create barriers to efficient workforce development and certification preparation. Traditional on-the-job training is typically conducted in person at centralized training facilities, requiring candidates to travel away from their primary work locations for extended periods. This travel requirement generates substantial expenses including transportation costs, accommodation fees, and per diem allowances that must be borne by employers or training candidates. The time spent traveling to and from training sites represents lost productivity for both the candidates and their employers, as personnel are unavailable for regular work duties during training periods. Additionally, coordinating schedules to bring multiple candidates together at a single location creates logistical challenges and may result in delays in certification timelines when scheduling conflicts arise. For instance, an NDT service provider with technicians distributed across multiple field offices may need to wait months to accumulate enough candidates to justify the expense of conducting a centralized training session.

While some remote training options have emerged to address the travel and expense issues associated with traditional in-person training, these conventional remote solutions have significant limitations that reduce their effectiveness for NDT certification preparation. Existing remote training platforms typically focus on delivering theoretical content through video lectures and written materials but fail to provide the practical hands-on experience that is essential for developing competency in NDT techniques. Without the ability to practice equipment operation, sample analysis, and flaw detection procedures, candidates are inadequately prepared for the practical portions of certification examinations that assess real-world testing skills. Furthermore, conventional remote training systems often suffer from large amounts of downtime between instruction sessions and utilize training personnel inefficiently by requiring one-to-one interactions rather than enabling trainers to supervise multiple candidates simultaneously. The lack of real-time feedback mechanisms in existing remote platforms means that candidates may develop incorrect techniques or misunderstandings that go uncorrected until formal examination, resulting in failed certification attempts and the need for additional training cycles. Accordingly, there is a need in the art for a system and method that provides the flexibility and cost savings of remote training while still delivering the practical hands-on experience and real-time instructor guidance that characterize effective in-person NDT training programs.

Accordingly, there is a need in the art for a system and method for remote NDT training that provides hands-on practical experience with real-time instructor guidance.

### SUMMARY

A system and method for remote NDT training is provided. In one aspect of the present invention, a system and platform is provided for non-destructive testing practical training. The system and platform comprises at least one server having an internet connection and storing a plurality of instructions comprising a user dashboard, a history module, an administrator module 430A, a test module 430B, a test viewer module 430C, a sample manager module 430D, a sample data module, and a live viewer module 430E; wherein the administrator module 430A causes the system to receive, via the internet connection, candidate information, and generate a candidate ID based upon the candidate information; wherein the test module 430B allows a candidate to input his/her data from the practical examinations that they have carried out on known samples that are in the system to generate, receive test input from a user, analyze the test input, and generate a test grade based upon the test input; wherein the test viewer module 430C causes the system to display tests; wherein the sample manager module 430D causes the system to receive sample inputs and generate test samples based upon the sample inputs; and wherein the live viewer module 430E causes the system to receive video and audio inputs from a first user device and relay the video and audio inputs to a second user device, with the first and second user devices communicating via an internet connection that passes through the at least one server. Augmented and virtual reality simulation of known samples in an AR environment with live communication from an instructor may be used as part of the live viewer module 430E.

The remote non-destructive testing training system provides a platform that enables NDT service providers to deliver hands-on practical training and pre-testing programs for certification preparation. The system comprises multiple modules including an administrator module, test module, test viewer module, sample manager module, and live viewer module that work together to facilitate remote training with real-time communication capabilities. The administrator module manages candidate information and generates unique candidate identifiers based upon received data such as candidate names and phone numbers, enabling organized tracking of individual training progress throughout the certification journey. The test module generates tests from stored test samples, receives and analyzes test inputs from candidates, generates test grades based upon the analysis, and archives all testing data for subsequent review by both candidates and trainers. The sample manager module enables trainers to add, edit, and update test samples to ensure training materials remain current and aligned with industry standards established by certification organizations. The live viewer module facilitates real-time video and audio communication between trainers and candidates through an internet connection, with the capability to generate and display augmented reality overlays that enhance visual instruction during remote training sessions.

The system maintains user profiles that store user data, training data, and test data within a database, enabling comprehensive tracking of candidate development and certification readiness. The test viewer module allows both candidates and trainers to review detailed test results and training feedback, displaying performance metrics including flaw detection accuracy, minimum dimension accuracy, and maximum dimension accuracy for completed testing activities. The administrator module provides candidate management functionality where users are added by inputting identifying information such as first name, last name, username, email, password, and company affiliation. The system employs permission levels that grant or restrict access to data based on user roles and administrator roles, ensuring that sensitive training information remains accessible only to authorized personnel. Trainers can monitor progress across multiple candidates simultaneously, identify common areas of difficulty, and adjust instructional approaches to address learning challenges in NDT certification preparation. The archiving functionality maintains detailed records of all training activities tied to individual candidate identifiers and group assignments, supporting long-term tracking of performance and providing evidence of training completion for certification documentation purposes.

A method for providing non-destructive testing training comprises receiving candidate information via a server having an internet connection, generating a candidate identifier based upon the candidate information, and generating a testing profile tied to the candidate identifier. The method further includes receiving test samples and test data, storing them on the server, generating tests based upon the test samples and test data, and tying the tests to the testing profile for organized tracking. Test inputs are received for generated tests, analyzed against known sample parameters and acceptable deviation tolerances, and test grades are generated based upon the analysis results. The method archives the test grade, test input, and test sample on the server for subsequent review, and updates test samples and test data based upon sample inputs received after initial reception. The live communication aspect of the method involves receiving video and audio inputs from a first user device and displaying them on a user interface of a second user device, enabling remote instruction between geographically separated participants. The method further includes generating and displaying augmented reality overlays on the video inputs, allowing a first user to provide oral and visual instruction to a second user utilizing enhanced visual annotations that highlight specific features, measurement points, or defect locations on test samples during training sessions.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the system and method disclosed herein. Those skilled in the pertinent art should also realize that such equivalent designs or modifications do not depart from the scope of the system and method of the present disclosure.

### BRIEF DESCRIPTION OF THE DRAWINGS

These and other features, aspects, and advantages of the present disclosure will become better understood with regard to the following description, appended claims, and accompanying drawings where:

FIG. 1 illustrates a system embodying features in accordance with an embodiment of the present invention;

FIG. 2 illustrates a system embodying features in accordance with an embodiment of the present invention;

FIG. 3 illustrates a system embodying features in accordance with an embodiment of the present invention;

FIG. 4 illustrates a schematic diagram of a system embodying features in accordance with an embodiment of the present invention;

FIG. 5 illustrates the various system modules in accordance with an embodiment of the present invention;

FIG. 6 illustrates an interface of the test viewer module in accordance with an embodiment of the present invention;

FIG. 7 illustrates an interface of the test viewer module in accordance with an embodiment of the present invention;

FIG. 8 illustrates an interface of the administrator module in accordance with an embodiment of the present invention;

FIG. 9 illustrates an interface of the administrator module in accordance with an embodiment of the present invention;

FIG. 10 illustrates an interface of the test module in accordance with an embodiment of the present invention;

FIG. 11 illustrates an interface of the sample manager module in accordance with an embodiment of the present invention;

FIG. 12 illustrates an interface of the test viewer module in accordance with an embodiment of the present invention;

FIG. 13 illustrates the manner in which individual access to data may be granted or limited based on user roles and administrator roles in accordance with an embodiment of the present invention; and

FIG. 14 illustrates a flow chart depicting certain method steps of a method embodying features in accordance with an embodiment of the present invention.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For instance, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises”, and grammatical equivalents thereof are used herein to mean that other components, steps, etc. are optionally present. For instance, a system “comprising” components A, B, and C can contain only components A, B, and C, or can contain not only components A, B, and C, but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility). As will be evident from the disclosure provided below, the present invention satisfies the need for a remote non-destructive testing training system and method capable of providing hands-on practical experience through digital platforms with real-time communication capabilities and augmented reality overlays that enhance remote NDT instruction and certification preparation.

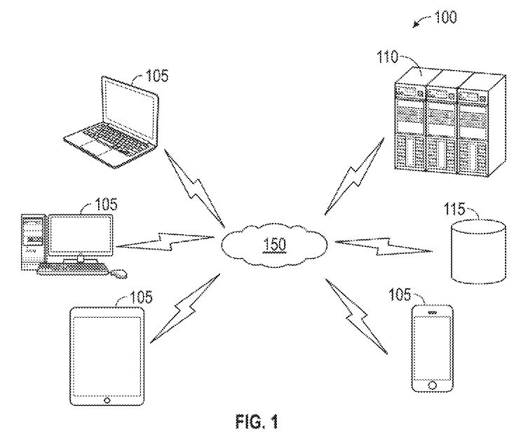

FIG. 1 depicts an exemplary environment 100 of the system 400 consisting of clients 105 connected to a server 110 and/or database 115 via a network 150. Clients 105 are devices of users 405 that may be used to access servers 110 and/or databases 115 through a network 150. A network 150 may comprise of one or more networks of any kind, including, but not limited to, a local area network (LAN), a wide area network (WAN), metropolitan area networks (MAN), a telephone network, such as the Public Switched Telephone Network (PSTN), an intranet, the Internet, a memory device, another type of network, or a combination of networks. In a preferred embodiment, computing entities 200 may act as clients 105 for a user 405. For instance, a client 105 may include a personal computer, a wireless telephone, a streaming device, a “smart” television, a personal digital assistant (PDA), a laptop, a smart phone, a tablet computer, or another type of computation or communication interface 280. Servers 110 may include devices that access, fetch, aggregate, process, search, provide, and/or maintain documents. Although FIG. 1 depicts a preferred embodiment of an environment 100 for the system 400, in other implementations, the environment 100 may contain fewer components, different components, differently arranged components, and/or additional components than those depicted in FIG. 1. Alternatively, or additionally, one or more components of the environment 100 may perform one or more other tasks described as being performed by one or more other components of the environment 100.

As depicted in FIG. 1, one embodiment of the system 400 may comprise a server 110. Although shown as a single server 110 in FIG. 1, a server 110 may, in some implementations, be implemented as multiple devices interlinked together via the network 150, wherein the devices may be distributed over a large geographic area and performing different functions or similar functions. For instance, two or more servers 110 may be implemented to work as a single server 110 performing the same tasks. Alternatively, one server 110 may perform the functions of multiple servers 110. For instance, a single server 110 may perform the tasks of a web server and an indexing server. Additionally, it is understood that multiple servers 110 may be used to operably connect the processor 220 to the database 115 and/or other content repositories. The processor 220 may be operably connected to the server 110 via wired or wireless connection. Types of servers 110 that may be used by the system 400 include, but are not limited to, search servers, document indexing servers, and web servers, or any combination thereof.

Search servers may include one or more computing entities 200 designed to implement a search engine, such as a documents/records search engine, general webpage search engine, etc. Search servers may, for instance, include one or more web servers designed to receive search queries and/or inputs from users 405, search one or more databases 115 in response to the search queries and/or inputs, and provide documents or information, relevant to the search queries and/or inputs, to users 405. In some implementations, search servers may include a web search server that may provide webpages to users 405, wherein a provided webpage may include a reference to a web server at which the desired information and/or links are located. The references to the web server at which the desired information is located may be included in a frame and/or text box, or as a link to the desired information/document. Document indexing servers may include one or more devices designed to index documents available through networks 150. Document indexing servers may access other servers 110, such as web servers that host content, to index the content. In some implementations, document indexing servers may index documents/records stored by other servers 110 connected to the network 150. Document indexing servers may, for instance, store and index content, information, and documents relating to user accounts and user-generated content. Web servers may include servers 110 that provide webpages to clients 105. For instance, the webpages may be HTML-based webpages. A web server may host one or more websites. As used herein, a website may refer to a collection of related webpages. Frequently, a website may be associated with a single domain name, although some websites may potentially encompass more than one domain name. The concepts described herein may be applied on a per-website basis. Alternatively, in some implementations, the concepts described herein may be applied on a per-webpage basis.

As used herein, a database 115 refers to a set of related data and the way it is organized. Access to this data is usually provided by a database management system (DBMS) consisting of an integrated set of computer software that allows users 405 to interact with one or more databases 115 and provides access to all of the data contained in the database 115. The DBMS provides various functions that allow entry, storage and retrieval of large quantities of information and provides ways to manage how that information is organized. Because of the close relationship between the database 115 and the DBMS, as used herein, the term database 115 refers to both a database 115 and DBMS.

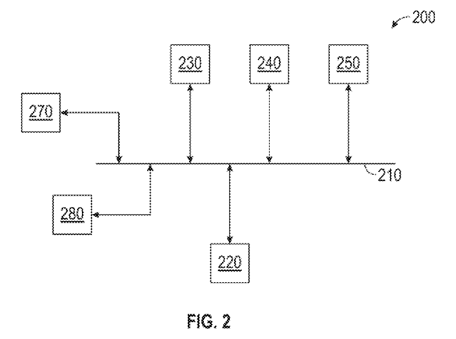

FIG. 2 is an exemplary diagram of a client 105, server 110, and/or or database 115 (hereinafter collectively referred to as “computing entity 200”), which may correspond to one or more of the clients 105, servers 110, and databases 115 according to an implementation consistent with the principles of the invention as described herein. The computing entity 200 may comprise a bus 210, a processor 220, memory 304, a storage device 250, a peripheral device 270, and a communication interface 280 (such as wired or wireless communication device). The bus 210 may be defined as one or more conductors that permit communication among the components of the computing entity 200. The processor 220 may be defined as logic circuitry that responds to and processes the basic instructions that drive the computing entity 200. Memory 304 may be defined as the integrated circuitry that stores information for immediate use in a computing entity 200. A peripheral device 270 may be defined as any hardware used by a user 405 and/or the computing entity 200 to facilitate communicate between the two. A storage device 250 may be defined as a device used to provide mass storage to a computing entity 200. A communication interface 280 may be defined as any transceiver-like device that enables the computing entity 200 to communicate with other devices and/or computing entities 200.

The bus 210 may comprise a high-speed interface 308 and/or a low-speed interface 312 that connects the various components together in a way such they may communicate with one another. A high-speed interface 308 manages bandwidth-intensive operations for computing device 300, while a low-speed interface 312 manages lower bandwidth-intensive operations. In some preferred embodiments, the high-speed interface 308 of a bus 210 may be coupled to the memory 304, display 316, and to high-speed expansion ports 310, which may accept various expansion cards such as a graphics processing unit (GPU). In other preferred embodiments, the low-speed interface 312 of a bus 210 may be coupled to a storage device 250 and low-speed expansion ports 314. The low-speed expansion ports 314 may include various communication ports, such as USB, Bluetooth, Ethernet, wireless Ethernet, etc. Additionally, the low-speed expansion ports 314 may be coupled to one or more peripheral devices 270, such as a keyboard, pointing device, scanner, and/or a networking device, wherein the low-speed expansion ports 314 facilitate the transfer of input data from the peripheral devices 270 to the processor 220 via the low-speed interface 312.

The processor 220 may comprise any type of conventional processor or microprocessor that interprets and executes computer readable instructions. The processor 220 is configured to perform the operations disclosed herein based on instructions stored within the system 400. The processor 220 may process instructions for execution within the computing entity 200, including instructions stored in memory 304 or on a storage device 250, to display graphical information for a graphical user interface (GUI) on an external peripheral device 270, such as a display 316. The processor 220 may provide for coordination of the other components of a computing entity 200, such as control of user interfaces 411A, 411B, 511, 711, applications run by a computing entity 200, and wireless communication by a communication interface 280 of the computing entity 200. The processor 220 may be any processor or microprocessor suitable for executing instructions. In some embodiments, the processor 220 may have a memory device therein or coupled thereto suitable for storing the data, content, or other information or material disclosed herein. In some instances, the processor 220 may be a component of a larger computing entity 200. A computing entity 200 that may house the processor 220 therein may include, but are not limited to, laptops, desktops, workstations, personal digital assistants, servers 110, mainframes, cellular telephones, tablet computers, smart televisions, streaming devices, or any other similar device. Accordingly, the inventive subject matter disclosed herein, in full or in part, may be implemented or utilized in devices including, but are not limited to, laptops, desktops, workstations, personal digital assistants, servers 110, mainframes, cellular telephones, tablet computers, smart televisions, streaming devices, or any other similar device.

Memory 304 stores information within the computing device 300. In some preferred embodiments, memory 304 may include one or more volatile memory units. In another preferred embodiment, memory 304 may include one or more non-volatile memory units. Memory 304 may also include another form of computer-readable medium, such as a magnetic, solid state, or optical disk. For instance, a portion of a magnetic hard drive may be partitioned as a dynamic scratch space to allow for temporary storage of information that may be used by the processor 220 when faster types of memory, such as random-access memory (RAM), are in high demand. A computer-readable medium may refer to a non-transitory computer-readable memory device. A memory device may refer to storage space within a single storage device 250 or spread across multiple storage devices 250. The memory 304 may comprise main memory 230 and/or read only memory (ROM) 240. In a preferred embodiment, the main memory 230 may comprise RAM or another type of dynamic storage device 250 that stores information and instructions for execution by the processor 220. ROM 240 may comprise a conventional ROM device or another type of static storage device 250 that stores static information and instructions for use by processor 220. The storage device 250 may comprise a magnetic and/or optical recording medium and its corresponding drive.

As mentioned earlier, a peripheral device 270 is a device that facilitates communication between a user 405 and the processor 220. The peripheral device 270 may include, but is not limited to, an input device and/or an output device. As used herein, an input device may be defined as a device that allows a user 405 to input data and instructions that is then converted into a pattern of electrical signals in binary code that are comprehensible to a computing entity 200. An input device of the peripheral device 270 may include one or more conventional devices that permit a user 405 to input information into the computing entity 200, such as a controller, scanner, phone, camera, scanning device, keyboard, a mouse, a pen, voice recognition and/or biometric mechanisms, etc. As used herein, an output device may be defined as a device that translates the electronic signals received from a computing entity 200 into a form intelligible to the user 405. An output device of the peripheral device 270 may include one or more conventional devices that output information to a user 405, including a display 316, a printer, a speaker, an alarm, a projector, etc. Additionally, storage devices 250, such as CD-ROM drives, and other computing entities 200 may act as a peripheral device 270 that may act independently from the operably connected computing entity 200. For instance, a streaming device may transfer data to a smartphone, wherein the smartphone may use that data in a manner separate from the streaming device.

The storage device 250 is capable of providing the computing entity 200 with substantial mass storage capabilities that support the comprehensive data management requirements of the remote non-destructive testing training system. In a preferred embodiment, the storage device 250 comprises multiple types of computer-readable media including memory 304, dedicated storage devices, and memory components integrated within the processor 220 architecture. The storage device 250 may include various physical and logical memory devices such as hard disk drives, solid-state drives, optical storage systems, and carrier wave technologies that facilitate data transmission and storage across the network infrastructure. As illustrated in FIG. 1, the storage device 250 operates in conjunction with the server 110 and database 115 to maintain persistent storage of training data, test samples, candidate information, and system configuration parameters. In some preferred embodiments, the storage device 250 may comprise arrays of interconnected storage devices configured in storage area networks or distributed storage configurations that provide redundancy and enhanced performance for the NDT training platform. The computer-readable medium functionality encompasses magnetic media such as hard disks and magnetic tape, optical media including CD ROM discs and DVDs, magneto-optical storage systems, and specialized hardware devices configured for storing and executing programming instructions including ROM 240, RAM, and flash memory components.

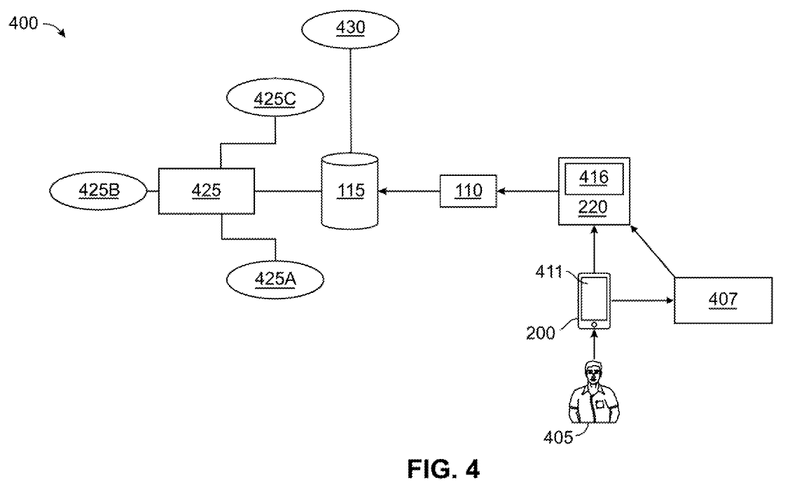

In another preferred embodiment, the programming instructions responsible for executing the various operations performed by the processor 220 are stored on a non-transitory computer-readable medium 416, which maintains a secure and persistent connection to both the server 110 and database 115 components of the system architecture. The non-transitory computer-readable medium 416 serves as the primary repository for all software modules, algorithms, and executable code that enable the administrator module 430A, test module 430B, test viewer module 430C, sample manager module 430D, and live viewer module 430E functionalities described throughout this disclosure. As illustrated in FIG. 4, the programming instructions may alternatively be integrated directly within the processor 220 architecture, providing enhanced performance and reduced latency for time-sensitive operations such as real-time video processing and augmented reality overlay generation. The non-transitory computer-readable medium 416 encompasses various storage technologies including magnetic storage systems such as hard disks and magnetic tape, optical storage media including CD ROM discs and DVDs, magneto-optical storage devices, and specialized hardware components specifically engineered for storing and executing programming instructions. In some preferred embodiments, the programming instructions are organized as discrete software modules within the non-transitory computer-readable medium 416, allowing for modular system updates, maintenance procedures, and feature enhancements without disrupting the overall system operation. The modular architecture facilitates efficient memory management and enables the system to dynamically load and execute specific functionality based on user requirements and system demands.

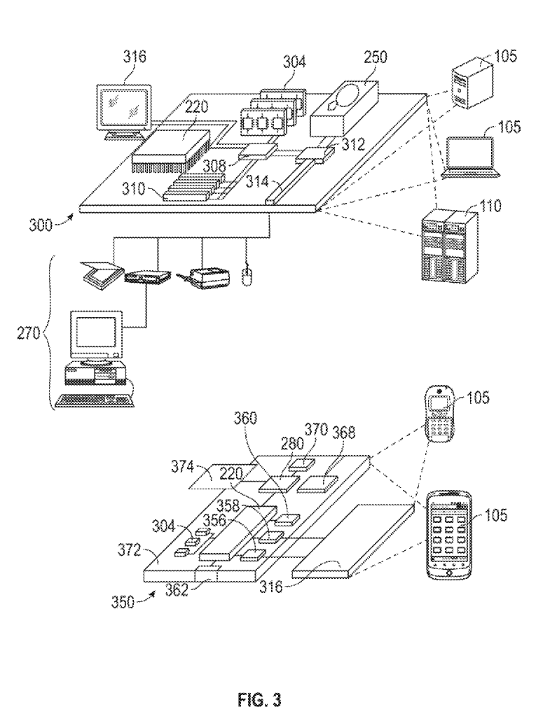

In a preferred embodiment, a comprehensive computer program is tangibly embodied within the storage device 250, containing detailed instructions that, when executed by the processor 220, perform the complete sequence of method steps required for remote non-destructive testing training and certification processes. The computer program encompasses all functional aspects of the system including candidate registration, test generation, sample management, live video communication, augmented reality overlay processing, and comprehensive data archiving capabilities that support the NDT training workflow. The instruction set within the computer program is transmitted to the processor 220 via the high-speed bus 210 architecture, ensuring efficient data transfer and minimal processing delays during system operation. As illustrated in FIG. 2 and FIG. 3, the computer program may be loaded from various computer-readable media sources including data storage device 250 or received from remote devices through the communication interface 280, providing flexibility in system deployment and maintenance procedures. In some preferred embodiments, the software instructions are dynamically loaded into memory 304 from secondary storage devices or received from networked systems via the communication interface 280, enabling real-time system updates and remote configuration management. The system architecture supports both software-based implementations and hardwired circuitry solutions, allowing for hybrid approaches that combine the flexibility of software control with the performance advantages of dedicated hardware components, thereby providing optimal performance for the diverse computational requirements of the NDT training platform.

FIG. 3 depicts exemplary computing entities 200 in the form of a computing device 300 and mobile computing device 350, which may be used to carry out the various embodiments of the invention as described herein. A computing device 300 is intended to represent various forms of digital computers, such as laptops, desktops, workstations, servers 110, databases 115, mainframes, and other appropriate computers. A mobile computing device 350 is intended to represent various forms of mobile devices, such as scanners, scanning devices, personal digital assistants, cellular telephones, smart phones, tablet computers, and other similar devices. The various components depicted in FIG. 3, as well as their connections, relationships, and functions are meant to be examples only, and are not meant to limit the implementations of the invention as described herein. The computing device 300 may be implemented in a number of different forms, as shown in FIGS. 1 and 3. For instance, a computing device 300 may be implemented as a server 110 or in a group of servers 110. Computing devices 300 may also be implemented as part of a rack server system. In addition, a computing device 300 may be implemented as a personal computer, such as a desktop computer or laptop computer. Alternatively, components from a computing device 300 may be combined with other components in a mobile device, thus creating a mobile computing device 350. Each mobile computing device 350 may contain one or more computing devices 300 and mobile devices, and an entire system may be made up of multiple computing devices 300 and mobile devices communicating with each other as depicted by the mobile computing device 350 in FIG. 3. The computing entities 200 consistent with the principles of the invention as disclosed herein may perform certain receiving, communicating, generating, output providing, correlating, and storing operations as needed to perform the various methods as described in greater detail below.

In the embodiment depicted in FIG. 3, a computing device 300 may include a processor 220, memory 304 a storage device 250, high-speed expansion ports 310, low-speed expansion ports 314, and bus 210 operably connecting the processor 220, memory 304, storage device 250, high-speed expansion ports 310, and low-speed expansion ports 314. In one preferred embodiment, the bus 210 may comprise a high-speed interface 308 connecting the processor 220 to the memory 304 and high-speed expansion ports 310 as well as a low-speed interface 312 connecting to the low-speed expansion ports 314 and the storage device 250. Because each of the components are interconnected using the bus 210, they may be mounted on a common motherboard as depicted in FIG. 3 or in other manners as appropriate. The processor 220 may process instructions for execution within the computing device 300, including instructions stored in memory 304 or on the storage device 250. Processing these instructions may cause the computing device 300 to display graphical information for a GUI on an output device, such as a display 316 coupled to the high-speed interface 308. In other implementations, multiple processors and/or multiple buses may be used, as appropriate, along with multiple memory units and/or multiple types of memory. Additionally, multiple computing devices may be connected, wherein each device provides portions of the necessary operations.

A mobile computing device 350 may include a processor 220, memory 304 a peripheral device 270 (such as a display 316, a communication interface 280, and a transceiver 368, among other components). A mobile computing device 350 may also be provided with a storage device 250, such as a micro-drive or other previously mentioned storage device 250, to provide additional storage. Preferably, each of the components of the mobile computing device 350 are interconnected using a bus 210, which may allow several of the components of the mobile computing device 350 to be mounted on a common motherboard as depicted in FIG. 3 or in other manners as appropriate. In some implementations, a computer program may be tangibly embodied in an information carrier. The computer program may contain instructions that, when executed by the processor 220, perform one or more methods, such as those described herein. The information carrier is preferably a computer- readable medium, such as memory, expansion memory 374, or memory 304 on the processor 220 such as ROM 240, that may be received via the transceiver or external interface 362. The mobile computing device 350 may be implemented in a number of different forms, as shown in FIG. 3. For instance, a mobile computing device 350 may be implemented as a cellular telephone, part of a smart phone, personal digital assistant, or other similar mobile device.

The processor 220 may execute instructions within the mobile computing device 350, including instructions stored in the memory 304 and/or storage device 250. The processor 220 may be implemented as a chipset of chips that may include separate and multiple analog and/or digital processors. The processor 220 may provide for coordination of the other components of the mobile computing device 350, such as control of the user interfaces 411A, 411B, 511, 711, applications run by the mobile computing device 350, and wireless communication by the mobile computing device 350. The processor 220 of the mobile computing device 350 may communicate with a user 405 through the control interface 358 coupled to a peripheral device 270 and the display interface 356 coupled to a display 316. The display 316 of the mobile computing device 350 may include, but is not limited to, Liquid Crystal Display (LCD), Light Emitting Diode (LED) display, Organic Light Emitting Diode (OLED) display, and Plasma Display Panel (PDP), holographic displays, augmented reality displays, virtual reality displays, or any combination thereof. The display interface 356 may include appropriate circuitry for causing the display 316 to present graphical and other information to a user 405. The control interface 358 may receive commands from a user 405 via a peripheral device 270 and convert the commands into a computer readable signal for the processor 220. In addition, an external interface 362 may be provided in communication with processor 220, which may enable near area communication of the mobile computing device 350 with other devices. The external interface 362 may provide for wired communications in some implementations or wireless communication in other implementations. In a preferred embodiment, multiple interfaces may be used in a single mobile computing device 350 as is depicted in FIG. 3.

Memory 304 stores information within the mobile computing device 350. Devices that may act as memory 304 for the mobile computing device 350 include, but are not limited to computer-readable media, volatile memory, and non-volatile memory. Expansion memory 374 may also be provided and connected to the mobile computing device 350 through an expansion interface 372, which may include a Single In-Line Memory Module (SIM) card interface or micro secure digital (Micro-SD) card interface. Expansion memory 374 may include, but is not limited to, various types of flash memory and non-volatile random-access memory (NVRAM). Such expansion memory 374 may provide extra storage space for the mobile computing device 350. In addition, expansion memory 374 may store computer programs or other information that may be used by the mobile computing device 350. For instance, expansion memory 374 may have instructions stored thereon that, when carried out by the processor 220, cause the mobile computing device 350 perform the methods described herein. Further, expansion memory 374 may have secure information stored thereon; therefore, expansion memory 374 may be provided as a security module for a mobile computing device 350, wherein the security module may be programmed with instructions that permit secure use of a mobile computing device 350. In addition, expansion memory 374 having secure applications and secure information stored thereon may allow a user 405 to place identifying information on the expansion memory 374 via the mobile computing device 350 in a non-hackable manner.

A mobile computing device 350 may communicate wirelessly through the communication interface 280, which may include digital signal processing circuitry where necessary. The communication interface 280 may provide for communications under various modes or protocols, including, but not limited to, Global System Mobile Communication (GSM), Short Message Services (SMS), Enterprise Messaging System (EMS), Multimedia Messaging Service (MMS), Code Division Multiple Access (CDMA), Time Division Multiple Access (TDMA), Personal Digital Cellular (PDC), Wideband Code Division Multiple Access (WCDMA), IMT Multi-Carrier (CDMAX 0) , and General Packet Radio Service (GPRS), or any combination thereof. Such communication may occur, for example, through a transceiver 368. Short-range communication may occur, such as using a Bluetooth, WIFI, or other such transceiver 368. In addition, a Global Positioning System (GPS) receiver module 370 may provide additional navigation-and location-related wireless data to the mobile computing device 350, which may be used as appropriate by applications running on the mobile computing device 350. Alternatively, the mobile computing device 350 may communicate audibly using an audio codec 360, which may receive spoken information from a user 405 and covert the received spoken information into a digital form that may be processed by the processor 220. The audio codec 360 may likewise generate audible sound for a user 405, such as through a speaker, e.g., in a handset of mobile computing device 350. Such sound may include sound from voice telephone calls, recorded sound such as voice messages, music files, etc. Sound may also include sound generated by applications operating on the mobile computing device 350.

The system 400 may also comprise a power supply. The power supply may be any source of power that provides the system 400 with power. In an embodiment, the power supply may be a stationary power outlet. The system 400 may comprise of multiple power supplies that may provide power to the system 400 in different circumstances. For instance, the system 400 may be directly plugged into a stationary power outlet, which may provide power to the system 400 so long as it remains in one place. However, the system 400 may also be connected to a backup battery so that the system 400 may receive power even when the power supply is not connected to a stationary power outlet or if the stationary power outlet ceases to provide power to the computing entity 200.

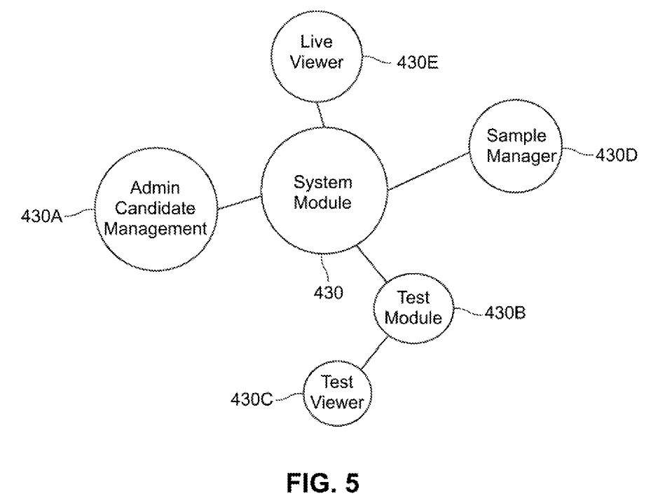

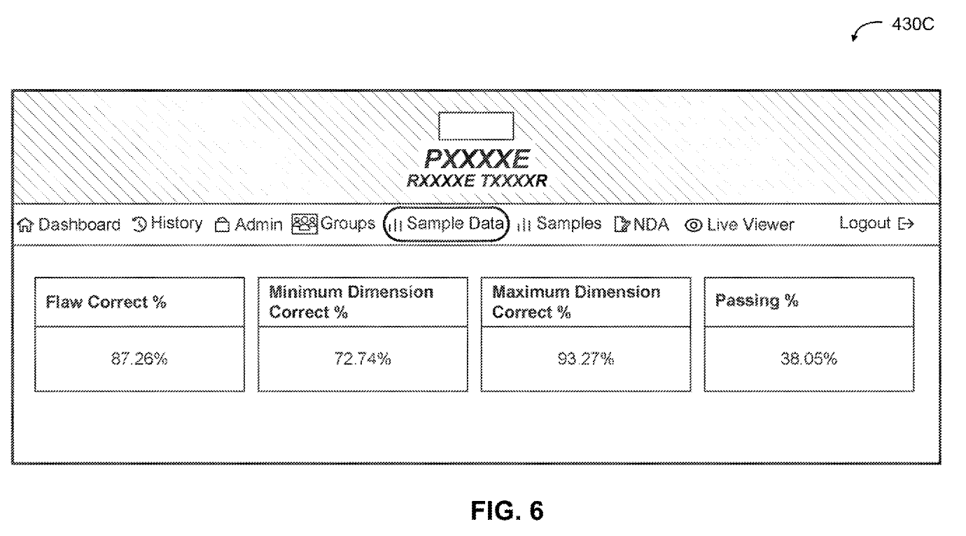

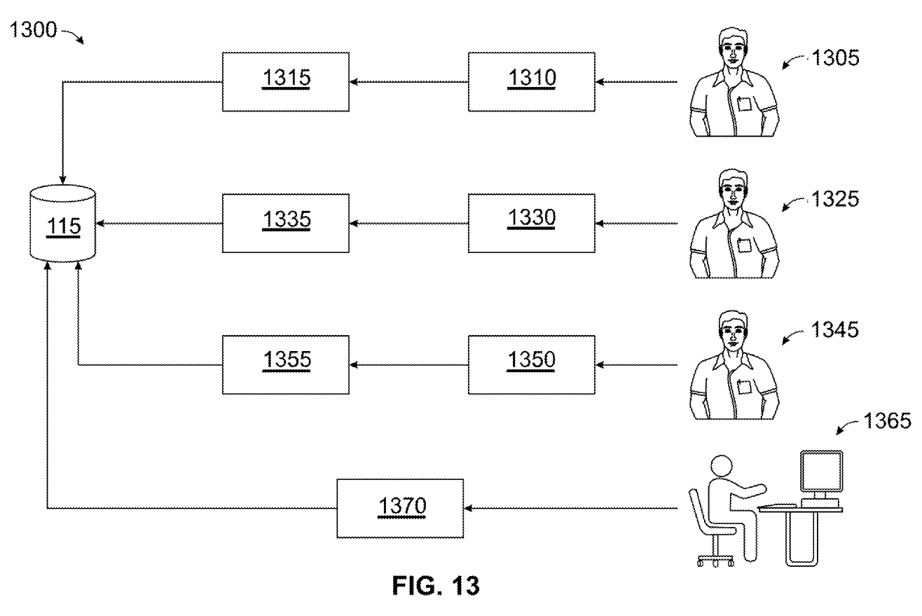

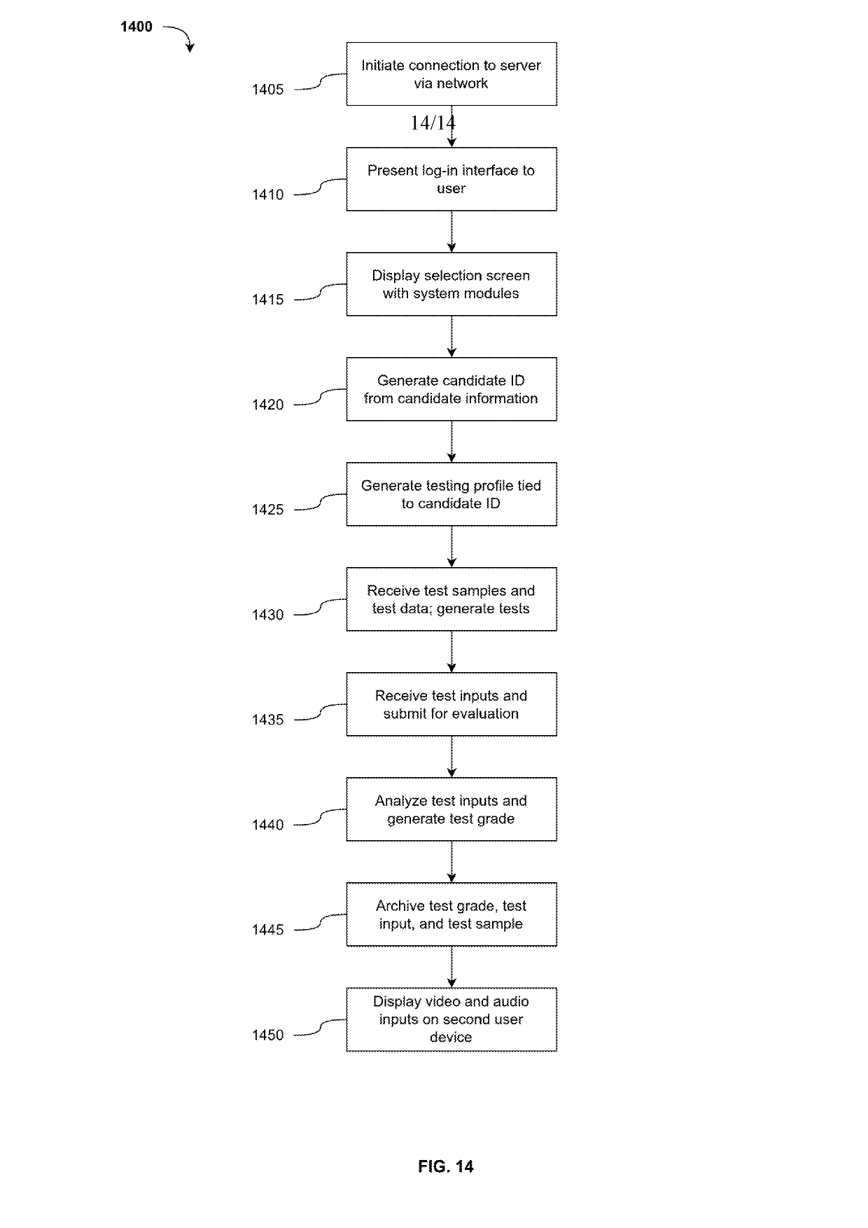

FIGS. 4-14 depict embodiments of a system 400 for remote non-destructive testing training and certification. FIG. 4 depicts a schematic diagram of the system 400 comprising a computing entity 200, processor 220, camera 407, and system modules 430. FIG. 5 depicts the various system modules 430, including the administrator module 430A, test module 430B, test viewer module 430C, sample manager module 430D, and live viewer module 430E. FIGS. 6-12 illustrate various user interface embodiments for the different system modules 430. FIG. 13 demonstrates the permission levels 1300 system controlling database 115 access, showing requesting users 1305, 1325, 1345 with their respective user roles 1310, 1330, 1350 and content access 1315, 1335, 1355, along with an administrator 1365 having administrator roles 1370 with broader system permissions. FIG. 14 shows a method that may be carried out by the system 400 for candidate registration, testing profile generation, and NDT certification processes. It is understood that the various method steps associated with the methods of the present disclosure may be carried out as operations by the system 400 shown in FIG. 4-13.

Generally, the system 400 enables non-destructive testing (NDT) service providers to effectively deliver comprehensive pre-requisite hands-on training and pre-testing programs ahead of actual standardized practical NDT certification examinations. The system 400, as illustrated in FIG. 4, provides a structured approach to remote non-destructive testing training and certification that allows service providers to assess candidate readiness and competency levels before committing resources to formal certification processes. The processor 220 coordinates with the database 115 to store and retrieve candidate performance metrics, enabling detailed analysis of individual progress throughout the training program. This capability enables NDT service providers to strategically place their personnel into appropriate training tiers based on individual skill levels and certification requirements. For example, a candidate demonstrating strong flaw detection accuracy but weak thickness measurement precision may be assigned to targeted training modules that address their specific deficiencies. The comprehensive assessment capabilities of the system 400 allow NDT service providers to optimize their training investments by identifying specific areas where individual candidates require additional instruction or practice before proceeding to formal certification testing.

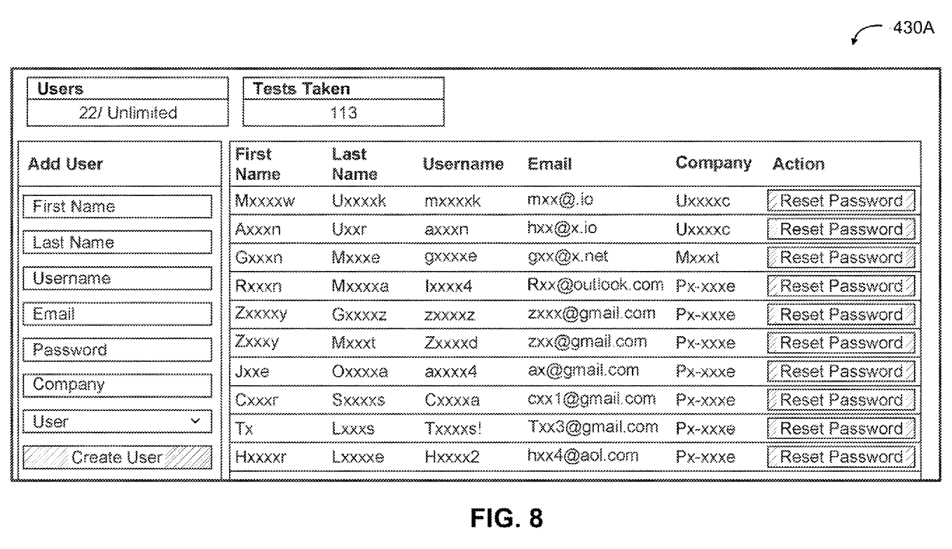

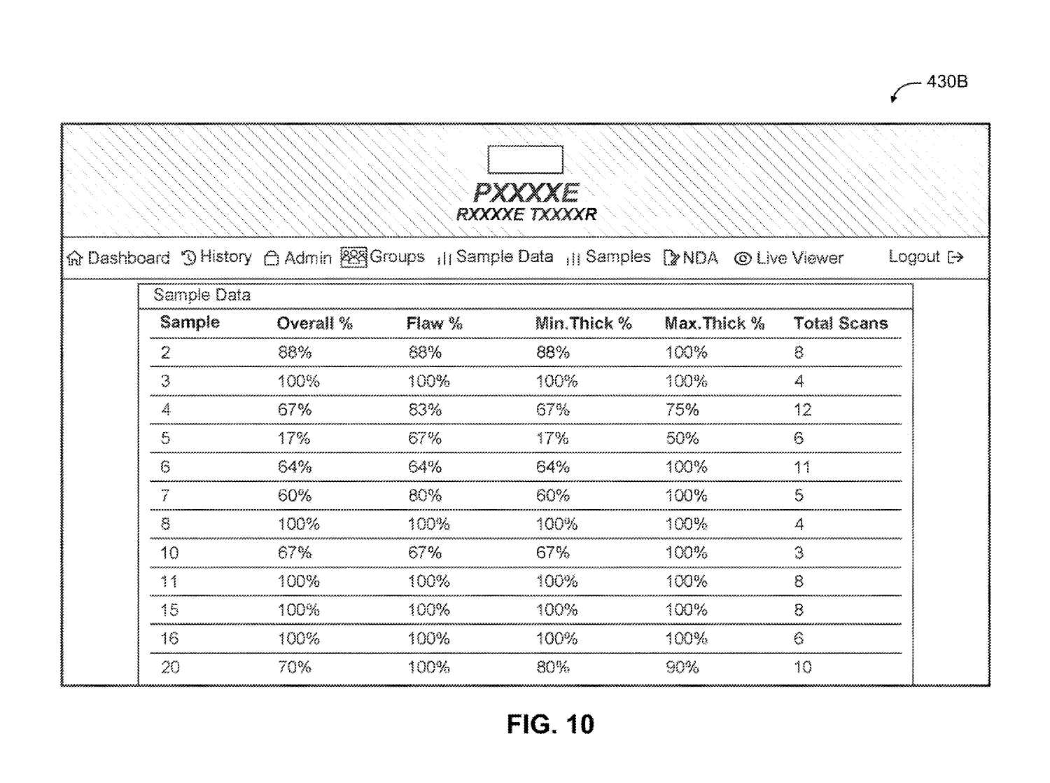

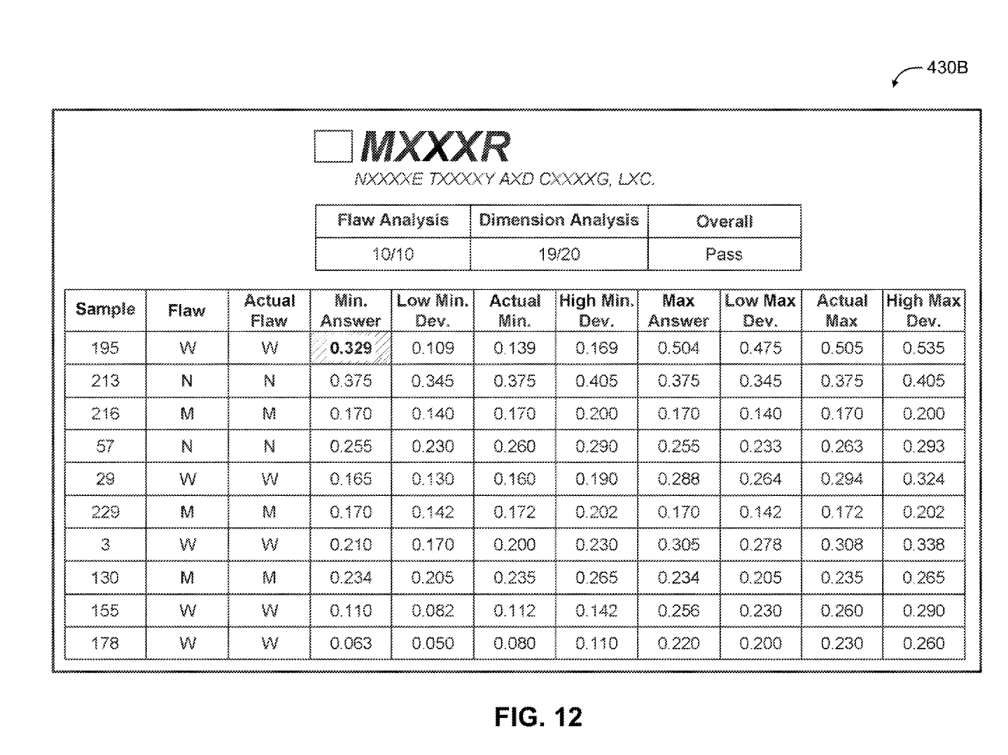

In another preferred embodiment, when an NDT service provider requires personnel certified to ASNT's ISQ Ultrasonic Thickness (ISQ-UTT) standards, the system 400 provides detailed analytics and performance tracking to determine which personnel need additional training to achieve certification readiness. The test module 430B, as illustrated in FIGS. 10 and 12, generates comprehensive test results that include flaw detection accuracy, thickness measurement precision, and overall competency scores for each candidate participating in the remote training program. The administrator module 430A, as illustrated in FIG. 8, allows training coordinators to monitor progress across multiple candidates simultaneously and identify those who are approaching certification readiness versus those who require extended training periods. The system 400 maintains detailed training data 425B and test data 425C within user profiles 425, enabling service providers to track individual progress over time and make informed decisions about when candidates are ready for formal certification testing. In some preferred embodiments, the system 400 may generate automated recommendations for additional training modules or suggest specific areas of focus based on candidate performance patterns observed during testing sessions. This data-driven approach to remote non-destructive testing training and certification ensures that resources are allocated efficiently and candidates receive targeted instruction where needed most throughout their certification preparation journey.

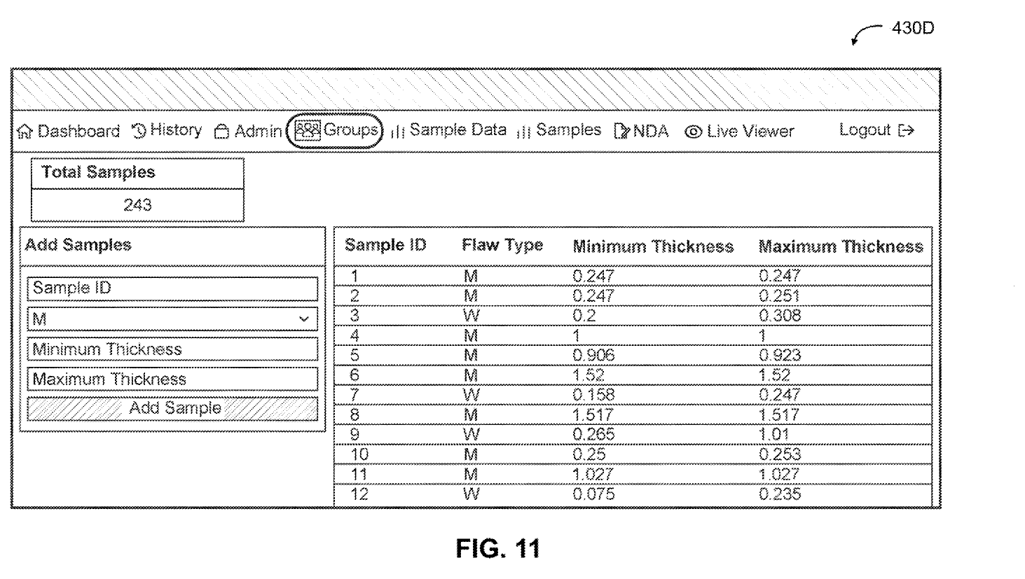

In a preferred embodiment, the system 400 thereby allows NDT service providers to better allocate training resources, resulting in significant cost savings and time efficiency improvements for their business operations and employee development programs. The live viewer module 430E, as illustrated in FIG. 5, enables real-time remote instruction that eliminates the need for expensive travel and accommodation costs associated with traditional in-person training programs conducted at centralized facilities. The sample manager module 430D, as illustrated in FIG. 11, allows trainers to efficiently manage and update test samples, ensuring that training materials remain current and relevant to industry standards and certification requirements established by organizations such as ASNT. In some preferred embodiments, the system 400 reduces training downtime for NDT candidates and trainers by providing flexible scheduling options that can be integrated into existing work schedules without disrupting operational activities at their primary work locations. For instance, a trainer located at a corporate headquarters may conduct live training sessions with candidates distributed across multiple field offices, eliminating the need to consolidate personnel at a single training facility. The comprehensive training platform enables NDT service providers to maintain consistent training quality while reducing the logistical challenges and expenses associated with traditional hands-on training methods, ultimately improving the overall efficiency and effectiveness of their remote non-destructive testing training and certification programs.

In a preferred embodiment, the system 400 generally comprises a processor 220 operably connected to the computing entity 200, a power supply, a display 316 operably connected to the processor 220, a non-transitory computer-readable medium 416 coupled to the processor 220 and having instructions stored thereon, and a database 115 operably connected to the processor 220. As illustrated in FIG. 4, the processor 220 coordinates all system operations, including candidate registration, test generation, sample management, and live video communication for NDT training applications. The power supply provides consistent electrical power to all system components, ensuring uninterrupted operation during remote training sessions and certification testing procedures. The display 316 presents visual information to users through various interface modules, enabling trainers and candidates to interact with test samples, view augmented reality overlays, and access training materials stored within the system 400. The non-transitory computer-readable medium 416 stores all software modules, training data, test samples, and candidate information necessary for comprehensive NDT training and certification processes. The database 115 maintains persistent storage of user profiles 425, training records, test results, and system configuration parameters that support the remote hands-on training capabilities of the platform.

In another preferred embodiment, a computing entity 200 having a user interface 411 may be operably connected to the processor 220 to facilitate user interaction with the remote NDT training system. As illustrated in FIG. 4, the user interface 411 provides access to the administrator module 430A, test module 430B, test viewer module 430C, sample manager module 430D, and live viewer module 430E, enabling comprehensive management of training programs and certification processes. The computing entity 200 processes user inputs, manages data flow between system components, and coordinates the execution of training exercises and competency assessments for candidates preparing for NDT certification examinations. In some preferred embodiments, the computing entity 200 may include multiple processing units that handle different aspects of the system 400, such as video processing for live viewer sessions, test grading algorithms, and augmented reality overlay generation. For example, a dedicated graphics processing unit may handle the rendering of augmented reality overlays while a separate processing unit manages the analysis of test inputs and generation of test grades. The system 400 adapts to different user roles, presenting via the user interface 411 appropriate functionality for candidates, trainers, and administrators based on their permission levels 1300 and system access requirements established during the registration process.

In some preferred embodiments, a server 110 may be operably connected to the database 115 and processor 220, facilitating the transfer of information between the processor 220 and database 115 for remote non-destructive testing training operations. As illustrated in FIGS. 1 and 4, the server 110 may manage network communications, user authentication, and data synchronization across multiple client devices 105 participating in NDT training sessions conducted through the network 150. The server architecture preferably supports concurrent access by multiple users, enabling simultaneous training sessions, test administration, and real-time communication between trainers and candidates located in different geographical locations. For instance, a trainer located at a corporate training facility may conduct live instruction sessions with candidates distributed across multiple field offices while the server 110 manages the video and audio streams between all participants. In another preferred embodiment, the server 110 may be configured to process requests from the administrator module 430A for candidate registration, the test module 430B for test generation and grading, and the live viewer module 430E for video and audio streaming during remote training sessions. The server 110 may implement load balancing and redundancy features to ensure consistent system availability and performance during peak usage periods when multiple NDT training programs are conducted simultaneously, while maintaining secure data transmission protocols and backup systems to protect sensitive training data and candidate information stored within the database 115.

In yet another preferred embodiment, a camera 407 may be operably connected to the processor 220, allowing for live training capabilities that enable hands-on practical experience in remote NDT applications. As illustrated in FIG. 4, the camera 407 captures real-time video of NDT testing procedures, equipment demonstrations, and sample analysis techniques that trainers can share with remote candidates during live training sessions conducted through the system 400. The camera 407 preferably supports high-definition video capture and streaming capabilities, ensuring that candidates can clearly observe detailed NDT procedures, instrument readings, and flaw identification techniques during remote instruction sessions. For example, when a trainer demonstrates ultrasonic thickness measurement techniques on a test sample, the camera 407 captures the positioning of the transducer, the instrument display readings, and the physical characteristics of the sample surface in sufficient detail for remote candidates to replicate the procedure accurately. In some preferred embodiments, the camera 407 may include multiple viewing angles, zoom capabilities, and specialized lighting configurations to optimize the visibility of NDT testing procedures and sample characteristics for remote viewing by candidates located at distant facilities. The camera 407 may be mounted on adjustable stands or articulating arms that allow trainers to position the viewing angle for optimal demonstration of specific testing techniques and equipment operations.

In another preferred embodiment, the live viewer module 430E processes video inputs from the camera 407 and integrates augmented reality overlays that highlight specific features, measurement points, or defect locations on test samples during training sessions. The camera integration enables trainers to provide immediate visual feedback and guidance to candidates, replicating the hands-on experience traditionally available only through in-person NDT training programs conducted at centralized facilities. For instance, a trainer may use the camera 407 to demonstrate proper probe placement for detecting corrosion pitting while the live viewer module 430E overlays measurement grids and defect indicators onto the video stream for candidate reference. In some preferred embodiments, the camera 407 may be configured to capture macro-level detail of surface conditions, weld profiles, and material discontinuities that are relevant to various NDT inspection methods including visual testing, liquid penetrant testing, and magnetic particle testing applications. The video captured by the camera 407 may be archived within the training data 425B stored in the database 115, allowing candidates to review demonstrations and training sessions at their convenience for reinforcement of learned techniques. The integration of the camera 407 with the processor 220 and live viewer module 430E creates a comprehensive remote training environment that supports effective knowledge transfer between experienced NDT professionals and candidates preparing for certification examinations.

The user interface 411 may be defined as a space where interactions between a user 405 and the system 400 may take place. In an embodiment, the interactions may take place in a way such that a user 405 may control the operations of the system 400. A user interface may include, but is not limited to operating systems, command line user interfaces, conversational interfaces, web-based user interfaces, zooming user interfaces, touch screens, task-based user interfaces, touch user interfaces, text-based user interfaces, intelligent user interfaces, brain-computer interfaces (BCIs), and graphical user interfaces, or any combination thereof. The system 400 may present data of the user interface to the user 405 via a display 316 operably connected to the processor 220. A display 316 may be defined as an output device that communicates data that may include, but is not limited to, visual, auditory, cutaneous, kinesthetic, olfactory, and gustatory, or any combination thereof.

Information presented via a display 316 may be referred to as a soft copy of the information because the information exists electronically and is presented for a temporary period of time. Information stored on the non-transitory computer-readable medium 416 may be referred to as the hard copy of the information. For instance, a display 316 may present a soft copy of visual information via a liquid crystal display (LCD), wherein the hardcopy of the visual information is stored on a local hard drive. For instance, a display 316 may present a soft copy of audio information via a speaker, wherein the hard copy of the audio information is stored in RAM. For instance, a display 316 may present a soft copy of tactile information via a haptic suit, wherein the hard copy of the tactile information is stored within a database 115. Displays 316 may include, but are not limited to, cathode ray tube monitors, LCD monitors, light emitting diode (LED) monitors, gas plasma monitors, screen readers, speech synthesizers, haptic feedback equipment, virtual reality headsets, speakers, and scent generating devices, or any combination thereof.

In a preferred embodiment, the various data of the system 400 may be stored in user profiles 425 that serve as centralized repositories for all information related to remote non-destructive testing training and certification activities. The user profiles 425, as illustrated in FIG. 4, maintain organized collections of user data 425A, training data 425B, and test data 425C that enable the system 400 to track individual candidate progress throughout their NDT certification journey. Each user profile 425 is preferably associated with a particular user 405 who may be a candidate seeking NDT certification, a trainer providing instruction, or an administrator managing the remote training platform. The system 400 creates and maintains these user profiles 425 to ensure that all training activities, test results, and certification progress are properly documented and accessible for review by authorized personnel. In some preferred embodiments, the user profiles 425 may include additional information such as certification expiration dates, specialized training requirements, and performance analytics that help trainers assess candidate readiness for formal NDT examinations. For example, a user profile 425 for a candidate preparing for ultrasonic testing certification may store historical test scores, completed training modules, and instructor notes regarding specific areas requiring additional practice.

In another preferred embodiment, a user 405 is preferably associated with a particular user profile 425 based on a unique username and Candidate ID that are generated during the initial registration process for remote non-destructive testing training programs. The administrator module 430A, as illustrated in FIG. 8, facilitates the creation of these unique identifiers by processing candidate information such as names, phone numbers, and company affiliations to generate distinctive Candidate IDs that prevent data conflicts and ensure proper user identification. The association between users 405 and their corresponding user profiles 425 enables the system 400 to maintain secure access controls and ensure that sensitive training data and test results are only accessible to authorized individuals. For instance, a trainer may access the user profiles 425 of candidates assigned to their training group while being restricted from viewing profiles of candidates assigned to other trainers within the same organization. In some preferred embodiments, the system 400 may support multiple authentication methods including biometric verification, two-factor authentication, or integration with existing corporate identity management systems to enhance security for remote NDT training platforms. The robust user identification system ensures that all training activities, test submissions, and certification progress are accurately attributed to the correct individuals throughout the remote non-destructive testing training and certification process.

In a preferred embodiment, the data management capabilities of the system 400 are organized within user profiles 425 that serve as structured repositories for information related to remote non-destructive testing training and certification activities. As illustrated in FIG. 4, the user profiles 425 maintain collections of user data 425A, training data 425B, and test data 425C that enable the system 400 to track individual candidate progress throughout their NDT certification journey. The database 115 operably connected to the processor 220 provides persistent storage and retrieval capabilities for these diverse data types, ensuring that all training activities and certification progress are properly documented and accessible for review by authorized personnel. In some preferred embodiments, the system 400 may categorize and index this information using database management techniques that optimize search performance and data integrity for remote non-destructive testing training applications. The organized structure of user profiles 425 enables trainers and administrators to efficiently monitor candidate development, identify areas requiring additional instruction, and generate reports on training effectiveness. In another preferred embodiment, the integration of these data management capabilities with the computing systems of FIGS. 1-3, as well as the enhanced system described by FIG. 4, provides a foundation for NDT training and certification programs that supports both individual candidate tracking and group performance analysis.

In a preferred embodiment, user data 425A may be defined as personal identification information that enables the system 400 to uniquely identify and authenticate each user 405 participating in remote non-destructive testing training programs. The user data 425A preferably comprises fundamental identification elements such as candidate names, usernames, phone numbers, email addresses, company affiliations, and other demographic information that facilitates proper user management and communication within the NDT training platform. As illustrated in FIG. 8, the administrator module 430A processes this user data 425A during the registration process to generate unique Candidate IDs that prevent data conflicts and ensure accurate tracking of individual training progress throughout the certification journey. The user data 425A stored within user profiles 425 enables the system 400 to maintain organized records that associate each participant with their specific training activities and test results. In some preferred embodiments, the user data 425A may also include specialized certification requirements, training level designations, and access permissions that determine which system modules 430 and training materials each user 405 can access within the platform. For example, a candidate preparing for ASNT ISQ-UTT certification would have their user data 425A configured to reflect their specific training requirements and competency assessment needs for ultrasonic thickness testing procedures. In another preferred embodiment, the user data 425A may include employment history, previous NDT certifications held, and supervisor contact information that enables trainers to coordinate with employers regarding candidate progress and scheduling requirements. The structured organization of user data 425A within the database 115 enables the system 400 to provide personalized training experiences and maintain detailed records of each participant's involvement in remote non-destructive testing training and certification activities.

In a preferred embodiment, training data 425B may be defined as detailed records of all hands-on practical experience and remote training sessions conducted through the system 400 for non-destructive testing certification preparation. The training data 425B preferably comprises documentation of training session recordings, instructor feedback, practical exercise results, competency assessments, and certification progress that collectively demonstrate a candidate's development in NDT techniques and principles. As illustrated in FIG. 5, the live viewer module 430E generates significant portions of training data 425B through real-time video and audio capture during remote instruction sessions, including augmented reality training interactions that enhance the hands-on learning experience. The training data 425B stored within user profiles 425 enables the system 400 to maintain organized records of each candidate's participation in remote non-destructive testing training programs conducted through the platform. In some preferred embodiments, the training data 425B may include performance analytics that track candidate improvement over time, identifying specific areas where additional instruction or practice is needed for successful NDT certification. For instance, training data 425B might document a candidate's progress in ultrasonic thickness testing procedures, recording their accuracy in flaw detection, measurement precision, and adherence to proper testing protocols during remote training sessions conducted via the live viewer module 430E.

In another preferred embodiment, the training data 425B captures information from multiple training modalities supported by the system 400, including live instruction sessions, recorded demonstrations, and interactive exercises that prepare candidates for formal NDT certification examinations. As illustrated in FIG. 4, the training data 425B is stored within the database 115 in association with individual user profiles 425, enabling trainers to access historical training records when assessing candidate readiness for certification testing. The systematic collection of training data 425B enables trainers to provide targeted instruction that addresses specific weaknesses identified during remote non-destructive testing training activities. In some preferred embodiments, the training data 425B may include timestamps, session durations, and participation metrics that help administrators evaluate the effectiveness of training programs and identify candidates who may benefit from additional practice opportunities. For example, a candidate preparing for magnetic particle testing certification may have training data 425B that documents their completion of equipment calibration exercises, surface preparation procedures, and defect interpretation training conducted through the system 400. The structured organization of training data 425B within the database 115 ensures that all training activities are properly documented and accessible for review by authorized personnel throughout the remote non-destructive testing training and certification process.

In a preferred embodiment, test data 425C may be defined as detailed records of NDT certification testing and sample analysis results that demonstrate candidate competency and readiness for formal certification examinations conducted through the system 400. The test data 425C preferably comprises documentation of test sample measurements, flaw identification results, thickness readings, material analysis data, test grades, and certification exam scores that collectively assess a candidate's proficiency in non-destructive testing techniques and methodologies. As illustrated in FIGS. 10 and 12, the test module 430B generates and processes test data 425C through automated grading systems that analyze candidate responses and provide immediate feedback on performance accuracy for each testing session. The test data 425C stored within user profiles 425 enables the system 400 to maintain organized records of each candidate's testing activities and certification progress throughout their participation in remote non-destructive testing training programs. In some preferred embodiments, the test data 425C may include statistical analysis of candidate performance patterns, enabling trainers to identify common areas of difficulty and adjust training programs accordingly for improved learning outcomes. For example, test data 425C might reveal that candidates consistently struggle with minimum thickness measurements in ultrasonic testing, prompting trainers to provide additional focused instruction in that specific area of NDT practice.

In another preferred embodiment, the test data 425C captures detailed information from each testing session conducted through the test module 430B, including timestamps, sample identifiers, measurement values, and grading outcomes that document candidate performance over time. The database 115 operably connected to the processor 220 provides persistent storage and retrieval capabilities for test data 425C, ensuring that all testing activities are properly documented and accessible for review by authorized personnel throughout the certification process. As illustrated in FIG. 4, the test data 425C is stored within user profiles 425 in association with individual Candidate IDs, enabling trainers to access historical testing records when assessing candidate readiness for formal NDT certification examinations. In some preferred embodiments, the test data 425C may include performance metrics such as flaw detection accuracy percentages, dimension measurement precision scores, and overall passing rates that provide quantitative assessments of candidate competency levels. The structured organization of test data 425C within the database 115 enables the system 400 to generate detailed progress reports, track certification readiness, and provide evidence-based recommendations for additional training or advancement to formal NDT certification testing. The integration of test data 425C with the test viewer module 430C allows both candidates and trainers to review historical performance and identify trends that inform future training activities and certification preparation strategies.

The database 115 may be operably connected to the processor 220 via wired or wireless connection. In a preferred embodiment, the database 115 is configured to store user data 425A, training data 425B, and test data 425C within user profiles 430. Alternatively, the user data 425A, training data 425B, and test data 425C may be stored within user profiles 430 on the non-transitory computer-readable medium 416. The database 115 may be a relational database such that the user data 425A, training data 425B, and test data 425C associated with each user profile 430 within the plurality of user profiles 430 may be stored, at least in part, in one or more tables. Alternatively, the database 115 may be an object database such that user data 425A, training data 425B, and test data 425C associated with each user profile 430 of the plurality of user profiles 430 may be stored, at least in part, as objects. In some instances, the database 115 may comprise a relational and/or object database and a server 110 dedicated solely to managing the user data 425A, training data 425B, and test data 425C in the manners disclosed herein.

As mentioned previously, the system 400 may comprise a user interface 411. Information within the user interface 411 presented via a display 316 may be referred to as a soft copy of the information because the information exists electronically and is presented for a temporary period of time. Information stored on the non-transitory computer-readable medium 416 may be referred to as the hard copy of the information. For instance, a display 316 may present a soft copy of visual information via a liquid crystal display (LCD), wherein the hardcopy of the visual information is stored on a local hard drive. For instance, a display 316 may present a soft copy of audio information via a speaker, wherein the hard copy of the audio information is stored in RAM. For instance, a display 316 may present a soft copy of tactile information via a haptic suit, wherein the hard copy of the tactile information is stored within a database 115. Displays 316 may include, but are not limited to, cathode ray tube monitors, LCD monitors, light emitting diode (LED) monitors, gas plasma monitors, screen readers, speech synthesizers, haptic feedback equipment, virtual reality headsets, speakers, and scent generating devices, or any combination thereof.

In a preferred embodiment, a selection screen of the user interface 411 provides access control and navigation capabilities that allow users to select and utilize at least one system module 430 or to safely exit the system 400 while maintaining data integrity and session security. The user interface 411 presents a structured menu system that organizes the various functional components of the remote non-destructive testing training and certification platform, enabling efficient workflow management for both candidates and trainers. As illustrated in FIG. 5, the at least one system module 430 comprises an administrator module 430A, test module 430B, test viewer module 430C, sample manager module 430D, and a live viewer module 430E, each designed to support specific aspects of NDT training and certification processes. The modular architecture of the system 400 enables users to access only the functionality required for their specific role within the remote non-destructive testing training program, whether they are candidates preparing for certification, trainers providing instruction, or administrators managing the overall training platform. For example, a candidate may access the test module 430B and test viewer module 430C to complete practice examinations and review their results, while a trainer may additionally access the sample manager module 430D to update testing materials. The selection screen may present these modules as selectable icons or menu items that respond to user input through touch, mouse click, or keyboard navigation.

In some preferred embodiments, the selection screen may include additional navigation features such as quick access buttons, recent activity summaries, and personalized dashboards that enhance user experience and operational efficiency within the remote non-destructive testing training platform. The user interface 411 may display status indicators that inform users of pending tests, upcoming training sessions scheduled through the live viewer module 430E, or notifications from trainers regarding performance feedback. As illustrated in FIG. 4, the user interface 411 connects to the computing entity 200 and processor 220, enabling responsive interaction with the system modules 430 stored on the server 110. In another preferred embodiment, the selection screen may adapt its displayed options based on the permission levels 1300 associated with the logged-in user, presenting only those modules for which the user has authorization. For instance, a candidate with limited permissions may see only the test module 430B and test viewer module 430C options, while an administrator with broader permissions may see all available system modules 430 including the administrator module 430A. The design of the user interface 411 ensures that all participants in remote non-destructive testing training and certification programs can efficiently access the tools and resources necessary for successful completion of their training objectives.

In a preferred embodiment, the administrator module 430A causes the system 400 to receive user data 425A and generate a unique candidate ID based upon the candidate information, facilitating secure and organized management of remote non-destructive testing training participants. As illustrated in FIG. 8, the administrator module 430A provides functionality that allows authorized users to add or edit candidate information through both automated processes during the registration workflow and manual data entry procedures when administrative oversight is required. The candidate information management capabilities of the administrator module 430A encompass a range of personal identification and professional qualification data that enables proper tracking and certification of individuals participating in NDT training programs. For example, the candidate information may include essential details such as the candidate's full name, company affiliation, contact email address, phone number, certification level requirements, and specialized training designations that determine their access to specific remote non-destructive testing training modules. In some preferred embodiments, the administrator module 430A may also capture additional professional information such as previous NDT experience, current certification status, training completion dates, and performance metrics that help trainers assess individual candidate readiness for formal certification examinations. The data collection and management features of the administrator module 430A ensure that all participants in remote non-destructive testing training and certification programs are properly registered, tracked, and supported throughout their educational journey.

In another preferred embodiment, the administrator module 430A includes administrative functions that enable authorized personnel to efficiently add, edit, and manage candidate information within the remote non-destructive testing training and certification platform. The administrative capabilities extend beyond basic data entry to include user management features such as group assignments, permission level modifications, training pathway customization, and progress monitoring that support NDT certification programs. As illustrated in FIG. 8, the administrator module 430A provides secure access controls that ensure only authorized trainers and administrative staff can modify sensitive candidate information, maintaining data integrity and privacy compliance throughout the remote non-destructive testing training process. For instance, when preparing candidates for ASNT ISQ-UTT certification, the administrator module 430A enables trainers to assign specific ultrasonic thickness testing modules, track individual progress through practical exercises, and generate detailed reports on candidate readiness for formal certification examinations. In some preferred embodiments, the administrative functions may include automated notification systems that alert trainers when candidates complete training milestones, achieve passing scores on practice tests, or require additional instruction in specific NDT techniques. The administrative capabilities of the administrator module 430A streamline the management of remote non-destructive testing training programs while ensuring that all participants receive appropriate guidance and support throughout their certification journey.

In a preferred embodiment, the administrator module 430A incorporates a Candidate ID creation function that provides for the automatic or manual generation of unique Candidate IDs for each individual participating in the remote non-destructive testing training and certification platform. The Candidate ID creation function utilizes algorithms that process candidate information entered into the system 400 to generate distinctive identifiers that prevent data conflicts and ensure accurate tracking of individual training progress throughout the NDT certification process. As illustrated in FIG. 8, the unique identification system enables the administrator module 430A to maintain organized records of all training activities, test results, and certification progress for each participant in remote non-destructive testing training programs. For example, the Candidate ID creation function may combine at least a portion of a candidate's phone number with the first two letters from their first or last name to create a unique alphanumeric identifier that distinguishes them from other participants in the training platform. In some preferred embodiments, the Candidate ID generation process may incorporate additional security features such as checksum validation, duplicate detection algorithms, and automatic formatting protocols that ensure consistency and reliability across the remote non-destructive testing training database. In another preferred embodiment, the identification system provided by the administrator module 430A enables trainers and administrators to efficiently manage large groups of candidates while maintaining accurate records of individual performance and certification status throughout their participation in NDT training programs.

In a preferred embodiment, the test module 430B causes the system 400 to generate tests from a plurality of test samples that simulate real-world remote non-destructive testing scenarios, enabling candidates to receive practical hands-on experience through digital platforms. As illustrated in FIG. 10, the test module 430B presents sample data in a tabular format showing performance metrics including overall percentages, flaw percentages, minimum thickness percentages, maximum thickness percentages, and total scan counts for each test sample. The test module 430B utilizes the unique Candidate ID generated by the administrator module 430A to create individualized testing profiles for each candidate participating in remote non-destructive testing training and certification programs. The testing profile generation process enables the system 400 to track individual candidate progress, customize test difficulty levels based on competency assessments, and provide targeted instruction that addresses specific areas requiring improvement in NDT techniques and principles. When candidates access their testing profiles, the test module 430B presents them with carefully curated samples that require non-destructive testing analysis, including ultrasonic thickness measurements, flaw detection procedures, and material integrity assessments that prepare them for formal certification examinations. For example, a candidate may be presented with a test sample requiring identification of flaw type and measurement of both minimum and maximum thickness values, with the test module 430B comparing the candidate's responses against known sample parameters stored within the database 115.

In another preferred embodiment, the test module 430B receives test input from candidates through structured input interfaces that capture detailed measurement data, flaw identification results, and analytical conclusions that demonstrate their understanding of remote non-destructive testing methodologies. As illustrated in FIG. 12, the test module 430B displays test results in a tabular format showing sample ID numbers, flaw designations, minimum answer values, deviation ranges, actual minimum values, maximum answer values, and corresponding deviation parameters for each analyzed sample. The test module 430B analyzes the test input using grading algorithms that compare candidate responses against established industry standards and generates test grades that reflect their readiness for professional NDT certification testing. In some preferred embodiments, the grading algorithms evaluate multiple parameters including flaw detection accuracy, dimension measurement precision within acceptable deviation ranges, and overall consistency across multiple test samples. The test module 430B stores each completed test with associated metadata including completion timestamps, performance scores, areas of difficulty, and trainer feedback that collectively document a candidate's progression through remote non-destructive testing training and certification programs. For instance, when a candidate submits thickness measurements for a test sample, the test module 430B compares the submitted values against the actual minimum and maximum thickness values while accounting for acceptable deviation tolerances to determine measurement accuracy.

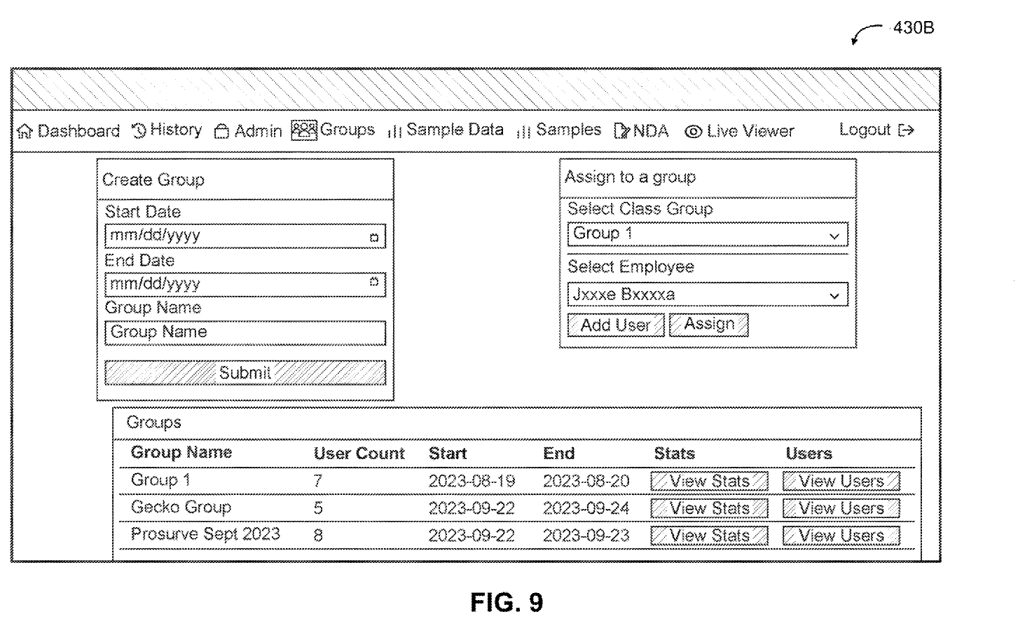

In a preferred embodiment, the test module 430B incorporates archiving functionality within a history module that maintains detailed records of all remote non-destructive testing training activities tied to individual Candidate IDs and group assignments. As illustrated in FIG. 9, the test module 430B interface displays group management functions including options for assigning users to groups, setting start and end dates for training periods, and viewing user statistics across different training groups. The secure storage system ensures that only authorized personnel, including the candidate linked to the specific Candidate ID and their assigned trainer, may access and review individual test results within the history module, maintaining data privacy and confidentiality throughout the remote non-destructive testing training process. The test module 430B also captures and stores real-time training feedback generated during live instruction sessions conducted through the live viewer module 430E, creating a record of interactive learning experiences that supplement traditional testing methodologies. In some preferred embodiments, the archiving capabilities extend to include video recordings of practical demonstrations, augmented reality training sessions, and performance analytics that enable trainers to assess candidate development over extended training periods. The integration of the test module 430B with the database 115 ensures persistent storage of all test data 425C within user profiles 425, enabling long-term tracking of candidate performance and certification readiness throughout their participation in NDT training programs.

The test viewer module causes the system to display selected groups of tests. In a preferred embodiment, the test viewer module 430C, as illustrated in FIG. 6, provides functionality that allows both trainers and candidates to review detailed test results and training feedback for all completed remote non-destructive testing training and certification activities undertaken by individual candidates. The test viewer module 430C enables systematic examination of candidate performance data, including flaw detection accuracy, thickness measurement precision, and overall competency scores that demonstrate proficiency in NDT techniques and principles. As illustrated in FIG. 6, the test viewer module 430C displays performance metrics in a tabular format showing Flaw Correct percentage, Minimum Dimension Correct percentage, Maximum Dimension Correct percentage, and Passing percentage values for each candidate's testing activities. The review capabilities of the test viewer module 430C provide trainers with detailed insights into each candidate's understanding of remote non-destructive testing methodologies, enabling them to identify specific areas where additional instruction or practice may be beneficial for successful certification preparation. For example, if a candidate consistently demonstrates difficulty with minimum thickness measurements in ultrasonic testing procedures, the trainer can utilize the test viewer module 430C to identify this pattern and provide targeted remedial instruction addressing that specific deficiency.

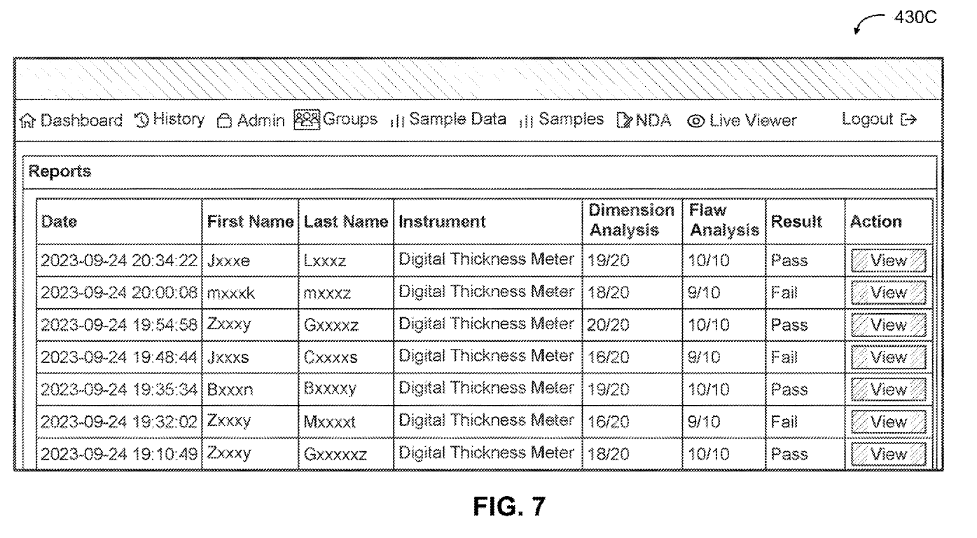

In some preferred embodiments, the test viewer module 430C may generate performance analytics that track candidate improvement over time, highlighting progress in specific NDT competency areas such as radiographic interpretation, magnetic particle testing, or liquid penetrant inspection techniques. The holistic view provided by the test viewer module 430C enables trainers to make informed decisions about candidate readiness for formal certification examinations and adjust training programs accordingly to optimize learning outcomes in remote non-destructive testing training and certification programs. The test viewer module 430C stores historical performance data within the database 115, allowing for longitudinal analysis of candidate development throughout their participation in NDT training programs. In another preferred embodiment, the test viewer module 430C, as illustrated in FIG. 7, provides authorized trainers with oversight capabilities that enable them to monitor and evaluate test results and training feedback for all candidates assigned to their supervision within the remote non-destructive testing training and certification platform. As illustrated in FIG. 7, the test viewer module 430C displays test data in a tabular format containing columns for Date, First Name, Last Name, Instrument, Dimension Analysis, Flaw Analysis, Result, and Action fields for each testing session. The multi-candidate monitoring functionality allows trainers to efficiently assess the performance of entire training groups simultaneously, identifying common areas of difficulty and adjusting instructional approaches to address widespread learning challenges in NDT certification preparation.

In a preferred embodiment, the test viewer module 430C presents comparative performance data that enables trainers to identify candidates who may require additional support or advanced instruction based on their demonstrated proficiency in remote non-destructive testing techniques and principles. For instance, a trainer preparing multiple candidates for ASNT ISQ-UTT certification can utilize the test viewer module 430C to compare ultrasonic thickness testing performance across the entire group, identifying candidates who consistently achieve high accuracy scores and those who require additional practice with specific measurement techniques. The test viewer module 430C integrates with the database 115 to retrieve stored test data 425C associated with individual user profiles 425, ensuring that all performance information is accurately attributed to the correct candidates. In some preferred embodiments, the test viewer module 430C may include automated alert systems that notify trainers when candidates achieve significant performance milestones or when intervention may be needed to address persistent learning difficulties. The group monitoring capabilities of the test viewer module 430C enable trainers to optimize resource allocation and ensure that all candidates receive appropriate levels of support throughout their participation in remote non-destructive testing training and certification programs. The test viewer module 430C may also provide filtering and sorting options that allow trainers to organize candidate data by performance metrics, completion dates, or specific testing categories to facilitate efficient review of training progress.

In a preferred embodiment, the test viewer module 430C incorporates document generation functionality that provides both candidates and trainers with the ability to create PDF documents containing detailed test results and training feedback for selected remote non-destructive testing training and certification activities. The PDF document creation function enables users to generate professional-quality printouts that serve as permanent records of training progress, certification milestones, and competency assessments that can be maintained for regulatory compliance and professional development documentation. As illustrated in FIG. 6, the test viewer module 430C displays performance metrics including Flaw Correct percentage, Minimum Dimension Correct percentage, Maximum Dimension Correct percentage, and Passing percentage values that may be exported into PDF format for archival purposes. The document generation capabilities of the test viewer module 430C support various formatting options and content selections, allowing users to customize reports based on specific requirements such as certification body standards, employer documentation needs, or personal training portfolios. For example, a candidate preparing for formal NDT certification examination may utilize the PDF creation function to generate training summaries that demonstrate their proficiency in ultrasonic testing, radiographic inspection, and other required competency areas for presentation to certification authorities. The generated PDF documents may include graphical representations of performance trends, detailed breakdowns of individual test scores, and summary statistics that provide clear evidence of candidate development throughout the training program.

In some preferred embodiments, the test viewer module 430C may include automated report templates that conform to industry standards such as ASNT guidelines, ensuring that generated documents meet professional requirements for remote non-destructive testing training and certification documentation. As illustrated in FIG. 7, the test viewer module 430C presents test data in a tabular format containing columns for Date, First Name, Last Name, Instrument, Dimension Analysis, Flaw Analysis, Result, and Action fields that may be selected for inclusion in generated PDF reports. The flexible document creation functionality enables trainers to generate detailed progress reports for individual candidates or group performance summaries that support administrative oversight and quality assurance processes within remote non-destructive testing training and certification programs. In another preferred embodiment, the test viewer module 430C may allow users to select specific date ranges, test categories, or performance thresholds when generating PDF documents to focus on particular aspects of training progress. For instance, a trainer may generate a PDF report showing only tests where candidates scored below passing thresholds to identify areas requiring additional instruction and remediation efforts. The document generation functionality integrates with the database 115 to retrieve stored test data 425C associated with individual user profiles 425, ensuring that all exported information accurately reflects the candidate's recorded performance throughout their participation in NDT training programs.

The sample manager module causes the system to receive sample inputs and generate test samples based upon the sample inputs. In a preferred embodiment, the sample manager module 430D, as illustrated in FIG. 11, provides functionality that enables authorized trainers to efficiently manage, add, edit, and update test samples utilized throughout remote non-destructive testing training and certification programs. The sample manager module 430D cooperates with the test module 430B to ensure that all testing materials remain current, relevant, and aligned with industry standards for NDT certification requirements. As illustrated in FIG. 5, the sample manager module 430D connects to the system module 430 and maintains communication pathways with other modules to facilitate coordinated sample management operations. The sample management capabilities enable trainers to maintain an extensive library of test samples that accurately represent real-world scenarios encountered in professional non-destructive testing applications. For example, trainers may utilize the sample manager module 430D to add new ultrasonic thickness testing samples that reflect recent advances in measurement techniques or incorporate updated flaw detection protocols that align with current ASNT certification standards. In some preferred embodiments, the sample manager module 430D may include automated validation features that verify the accuracy and completeness of sample data before integration into the remote non-destructive testing training platform. The sample management functionality ensures that candidates receive exposure to diverse testing scenarios that prepare them for the challenges they will encounter during formal NDT certification examinations.

In another preferred embodiment, the sample manager module 430D incorporates editing and updating functions that allow trainers to continuously refine and improve existing test samples based on candidate performance data and evolving industry requirements for remote non-destructive testing training and certification. As illustrated in FIG. 11, the sample manager module 430D displays sample data in tabular format containing columns for Sample ID, Flaw Type, Minimum Thickness, and Maximum Thickness values that trainers may modify as needed. The editing capabilities enable trainers to modify sample parameters such as flaw dimensions, material thickness measurements, and defect characteristics to optimize learning outcomes and address specific areas where candidates demonstrate difficulty. When analysis of training data reveals that particular test samples are causing confusion or misunderstanding among candidates, trainers can utilize the sample manager module 430D to clarify instructions, adjust measurement tolerances, or provide additional contextual information that enhances understanding of NDT techniques and principles. For instance, if candidates consistently struggle with identifying minimum thickness measurements in a specific ultrasonic testing sample, the trainer may edit the sample to include clearer measurement guidelines or add visual indicators that highlight the areas requiring analysis. In some preferred embodiments, the sample manager module 430D may maintain version control functionality that tracks all modifications made to test samples, enabling trainers to review the evolution of training materials and assess the effectiveness of changes over time. The editing capabilities ensure that the remote non-destructive testing training platform remains responsive to candidate needs and maintains alignment with current certification standards established by organizations such as ASNT.

In a preferred embodiment, the sample manager module 430D provides dynamic updating capabilities that enable trainers to incorporate new NDT techniques, emerging industry standards, and advanced testing methodologies into existing test samples within the remote non-destructive testing training platform. The updating functionality allows trainers to modify test samples in response to technological advances, regulatory changes, or feedback from certification bodies such as ASNT, maintaining the relevance and accuracy of training materials throughout the certification process. As illustrated in FIG. 11, the sample manager module 430D displays sample data in tabular format containing columns for Sample ID, Flaw Type, Minimum Thickness, and Maximum Thickness values that trainers may update as industry requirements evolve. When new NDT techniques are established or existing procedures are refined, trainers can utilize the sample manager module 430D to update testing samples accordingly, providing candidates with opportunities to practice these new methodologies and develop proficiency before encountering them in formal certification examinations. For example, if advances in phased array ultrasonic testing require updated calibration procedures or modified measurement protocols, trainers can edit existing samples to incorporate these changes and ensure that candidates receive appropriate preparation for current industry practices. The proactive updating capabilities of the sample manager module 430D ensure that the remote non-destructive testing training platform remains current with evolving industry standards and provides candidates with relevant and effective preparation for NDT certification success.

In some preferred embodiments, the sample manager module 430D may include automated notification systems that alert trainers when industry standards are updated or when new certification requirements are published by organizations such as ASNT, prompting timely updates to training materials stored within the database 115. The notification functionality enables trainers to maintain awareness of changes in NDT certification requirements without requiring manual monitoring of industry publications and regulatory announcements. As illustrated in FIG. 5, the sample manager module 430D connects to the system module 430 and maintains communication pathways with other modules to facilitate coordinated sample management operations across the remote non-destructive testing training platform. In another preferred embodiment, the sample manager module 430D may track modification histories for each test sample, enabling trainers to review previous versions and understand how training materials have evolved over time in response to changing industry requirements. For instance, a trainer may review the modification history of an ultrasonic thickness testing sample to understand how measurement tolerance requirements have changed following updates to ASNT ISQ-UTT certification standards. The version tracking capabilities support quality assurance processes and enable trainers to verify that all test samples within the remote non-destructive testing training platform accurately reflect current certification requirements and industry best practices.

The live viewer module causes the system to receive video and audio inputs from a first user device and relay the video and audio inputs to a second user device, with the first and second user devices communicating via an internet connection that passes through the at least one server. In a preferred embodiment, the live viewer module 430E provides real-time communication capabilities that enable both trainers and candidates to conduct remote non-destructive testing training and certification sessions with instantaneous feedback and interactive instruction. As illustrated in FIG. 5, the live viewer module 430E connects to the system module 430 and facilitates seamless video and audio transmission between geographically separated participants, eliminating the traditional barriers associated with hands-on NDT training while maintaining the quality and effectiveness of practical instruction. The system 400 utilizes the live viewer module 430E to create virtual training environments where experienced NDT professionals can guide candidates through testing procedures, equipment operation, and sample analysis techniques in real-time. For example, a trainer located at a corporate headquarters may demonstrate proper ultrasonic transducer placement techniques while a candidate at a remote field office observes and replicates the procedure on their own equipment. The live viewer module 430E integrates with the camera 407 and user interface 411, as illustrated in FIG. 4, to capture high-definition video of NDT testing procedures, equipment demonstrations, and sample analysis techniques that trainers can share with remote candidates during live instruction sessions.

In some preferred embodiments, the live viewer module 430E may support multiple concurrent training sessions, allowing a single trainer to supervise several candidates simultaneously or enabling collaborative learning experiences between multiple participants located at different facilities. The live viewer module 430E processes video streams through the server 110 and processor 220, as illustrated in FIG. 4, to ensure consistent delivery of training content across varying network conditions and bandwidth limitations. In another preferred embodiment, the live viewer module 430E may include advanced streaming capabilities that optimize video quality and minimize latency to ensure that candidates can clearly observe detailed NDT procedures, instrument readings, and flaw identification techniques during remote training sessions. For instance, when a trainer demonstrates magnetic particle testing procedures, the live viewer module 430E transmits the video feed with sufficient clarity for candidates to observe the formation of particle indications at defect locations on the test sample surface. The live viewer module 430E stores session recordings within the training data 425B associated with individual user profiles 425 in the database 115, enabling candidates to review instruction sessions at their convenience. The integration of the live viewer module 430E with the other system modules 430 creates a unified platform for remote non-destructive testing training and certification preparation.

In a preferred embodiment, the live viewer module 430E incorporates augmented reality (AR) functionality that enables trainers to provide enhanced visual instruction and guidance to candidates participating in remote non-destructive testing training and certification programs. The AR function allows trainers to overlay digital annotations, measurement indicators, and instructional graphics directly onto live video feeds of NDT testing procedures, creating an immersive learning experience that closely replicates hands-on training environments. As illustrated in FIG. 4, the live viewer module 430E utilizes the processor 220 to generate AR overlays that highlight specific features on test samples, demonstrate proper equipment positioning, and illustrate the location of defects or anomalies that candidates must identify during their certification training. For example, when conducting ultrasonic thickness testing training, trainers may utilize the AR function to overlay measurement grids, thickness readings, and defect indicators onto live video of test samples, enabling candidates to visualize proper testing techniques and understand the relationship between instrument readings and actual material conditions. The AR overlays are transmitted through the server 110 along with the video and audio streams to the second user device, ensuring synchronized display of instructional content. In some preferred embodiments, the AR function may include interactive elements that allow candidates to manipulate virtual testing tools, adjust measurement parameters, or practice defect identification procedures within the augmented reality environment displayed on their user interface 411.

In another preferred embodiment, the live viewer module 430E may generate three-dimensional AR overlays that demonstrate how various types of defects such as corrosion, cracks, or material thinning appear in different NDT testing methods, providing candidates with visual references for successful certification preparation and professional competency development. The AR functionality enables trainers to draw attention to specific areas of interest on test samples by circling defect locations, adding directional arrows, or inserting text labels that explain the significance of observed indications. As illustrated in FIG. 5, the live viewer module 430E operates in coordination with the test module 430B and sample manager module 430D to ensure that AR overlays correspond accurately to the test samples being analyzed during training sessions. For instance, when a candidate is practicing flaw detection on a sample containing known defects, the trainer may use the AR function to reveal the actual defect locations after the candidate has completed their initial assessment, providing immediate feedback on detection accuracy. The live viewer module 430E stores AR session data within the training data 425B in the database 115, allowing for subsequent review and analysis of training interactions. The integration of AR capabilities within the live viewer module 430E distinguishes the remote non-destructive testing training platform from conventional video conferencing solutions by providing specialized instructional tools designed specifically for NDT certification preparation.

In a preferred embodiment, the system 400 may use artificial intelligence (AI) techniques to perform functions of the system 400, wherein the AI techniques enable enhanced analysis of NDT test results and optimization of training content delivery through the user interface 411. As illustrated in FIG. 4, the AI techniques may be implemented through instructions stored on the non-transitory computer-readable medium 416 and executed by the processor 220 to analyze candidate performance patterns and optimize the presentation of training materials within the system 400. In one preferred embodiment, AI techniques may be used to control the selection and sequencing of test samples presented to candidates based on contextual factors such as the type of NDT certification being pursued, the candidate's demonstrated proficiency levels, and historical performance patterns stored within the user profile 425. For example, when a candidate demonstrates difficulty with flaw detection in ultrasonic thickness testing, the AI techniques may automatically adjust the training pathway to present additional samples focusing on flaw identification techniques, optimizing the learning experience based on the detected candidate needs. In yet another preferred embodiment, AI techniques may be used to organize the plurality of test samples within the sample manager module 430D by analyzing the relationships between different defect types and arranging the test samples in a manner that facilitates progressive skill development through the test module 430B. The AI techniques may continuously learn from candidate interactions with test samples to refine the organization of training materials over time, adapting to individual candidate learning patterns and certification requirements.

In some preferred embodiments, AI techniques may be used to determine which training modules and test samples should be presented to a candidate based on user data 425A and test data 425C of the user profile 425 associated with the candidate. As illustrated in FIGS. 6 and 7, the test viewer module 430C presents performance metrics from multiple testing sessions, and the AI techniques may analyze user data 425A including certification goals, training history, and performance trends to select training content that aligns with the specific needs of the particular candidate. In another preferred embodiment, the AI techniques may analyze patterns in candidate test inputs within the test module 430B to predict which NDT techniques the candidate is likely to struggle with, enabling proactive presentation of relevant training materials within the system 400. For example, when the AI techniques detect that a candidate frequently submits inaccurate minimum thickness measurements during testing sessions, the system 400 may automatically present additional calibration training exercises and measurement technique demonstrations through the live viewer module 430E when the candidate begins their next training session. The term "artificial intelligence" and grammatical equivalents thereof are used herein to mean an intelligence method used by the system 400 to correctly interpret and learn from data of the system 400 or a plurality of systems in order to achieve specific goals and tasks through flexible adaptation. Types of intelligence methods that may be used by the system 400 include, but are not limited to, machine learning, neural network, computer vision, natural language processing, or any combination thereof.

In a preferred embodiment, the AI techniques enable the system 400 to dynamically generate training recommendations and test sample selections that correspond to competencies most relevant to the current certification goals of the candidate. As illustrated in FIG. 5, the system module 430 coordinates the administrator module 430A, test module 430B, test viewer module 430C, sample manager module 430D, and live viewer module 430E, wherein the AI techniques may determine the arrangement and sequencing of training activities based on candidate performance analysis. In some preferred embodiments, an AI assistant integrated within the system 400 may respond to candidate performance patterns by providing personalized training recommendations, identifying areas requiring additional practice, or automating the scheduling of live training sessions with trainers through the live viewer module 430E. For example, when a candidate completes a series of tests through the test module 430B, the AI assistant may analyze the candidate's performance metrics stored within the test data 425C and present a customized training plan showing recommended practice areas, suggested test samples, and available live training sessions tailored to the candidate's demonstrated weaknesses. In another preferred embodiment, the AI assistant may interpret the test results currently being displayed within the test viewer module 430C to generate contextually relevant training suggestions, such as recommending specific flaw detection exercises when the candidate's performance data indicates difficulty with identifying certain defect types. The AI techniques may also analyze the candidate's certification timeline, their progress through required training modules, and upcoming examination dates stored within the user profile 425 to proactively suggest training activities through the system 400.

In another preferred embodiment, the AI techniques may utilize computer vision capabilities to enhance the functionality of the live viewer module 430E within the system 400. As illustrated in FIG. 4, the camera 407 operably connected to the computing entity 200 captures video of NDT testing procedures and sample analysis, and the AI techniques may process these images to automatically identify defect locations, measurement points, and equipment positioning to assist trainers in providing augmented reality overlays during remote instruction sessions. In some preferred embodiments, the computer vision capabilities may enable the system 400 to recognize NDT equipment configurations or sample characteristics when conducting live training, allowing for automated annotation of video feeds with relevant technical information. For example, a trainer conducting remote ultrasonic thickness testing instruction may position the transducer on a test sample, and the AI techniques may interpret the equipment placement to automatically generate measurement grid overlays and highlight optimal probe positioning through the live viewer module 430E without requiring manual annotation by the trainer. In a preferred embodiment, the AI techniques may analyze video data captured by the camera 407 to verify proper testing technique execution when candidates perform practical exercises, providing an additional layer of quality assurance for remote NDT training and certification preparation. The computer vision capabilities may also enable the system 400 to detect when candidates are performing testing procedures incorrectly and automatically alert trainers through the live viewer module 430E to provide corrective guidance.

In some preferred embodiments, the AI techniques may employ neural network algorithms to learn from candidate interactions with test samples and improve the accuracy of training recommendations over time. As illustrated in FIG. 6, the test viewer module 430C displays performance metrics including flaw detection accuracy, minimum dimension accuracy, and maximum dimension accuracy, and the neural network algorithms may analyze patterns in candidate performance to optimize the selection and sequencing of test samples within the test module 430B. In a preferred embodiment, the neural network algorithms may process user data 425A, training data 425B, and test data 425C to generate a comprehensive understanding of candidate learning patterns and certification readiness that informs the dynamic generation of training pathways within the system 400. For example, a neural network trained on performance data from multiple candidates across various NDT certification programs may identify common patterns in skill development and automatically configure the test module 430B to present test samples in sequences that optimize learning outcomes for candidates preparing for ASNT certification examinations. In another preferred embodiment, the neural network algorithms may detect anomalies in candidate performance that indicate potential issues, such as a candidate whose measurement accuracy has declined over recent testing sessions, and may present recommendations for additional training or suggest scheduling a live instruction session through the live viewer module 430E. The AI techniques continuously refine their models based on feedback from candidate performance on tests and training exercises, enabling the system 400 to provide increasingly personalized and effective remote non-destructive testing training experiences over time.

The system 400 preferably uses machine learning techniques to perform the methods disclosed herein, wherein the instructions carried out by the processor 220 for said machine learning techniques are stored on the non-transitory computer-readable medium 416, server 110, and/or database 115. Machine learning techniques that may be used by the system 400 include, but are not limited to, classification algorithms, neural network algorithm, regression algorithms, decision tree algorithms, clustering algorithms, genetic algorithms, supervised learning algorithms, semi-supervised learning algorithms, unsupervised learning algorithms, deep learning algorithms, or other types of algorithms. More specifically, machine learning algorithms can include implementations of one or more of the following algorithms: support vector machine, decision tree, nearest neighbor algorithm, random forest, ridge regression, Lasso algorithm, k-means clustering algorithm, boosting algorithm, spectral clustering algorithm, mean shift clustering algorithm, non-negative matrix factorization algorithm, elastic net algorithm, Bayesian classifier algorithm, RANSAC algorithm, orthogonal matching pursuit algorithm, bootstrap aggregating, temporal difference learning, backpropagation, online machine learning, Q-learning, stochastic gradient descent, least squares regression, logistic regression, ordinary least squares regression (OLSR), linear regression, stepwise regression, multivariate adaptive regression splines (MARS), locally estimated scatterplot smoothing (LOESS) ensemble methods, clustering algorithms, centroid based algorithms, principal component analysis (PCA), singular value decomposition, independent component analysis, k nearest neighbors (kNN), learning vector quantization (LVQ), self-organizing map (SOM), locally weighted learning (LWL), apriori algorithms, eclat algorithms, regularization algorithms, ridge regression, least absolute shrinkage and selection operator (LASSO), elastic net, classification and regression tree (CART), iterative dichotomiser 3 (ID3), C4.5 and C5.0, chi-squared automatic interaction detection (CHAID), decision stump, M5, conditional decision trees, least-angle regression (LARS), naive bayes, gaussian naïve bayes, multinomial naïve bayes, averaged one-dependence estimators (AODE), bayesian belief network (BBN), bayesian network (BN), k-medians, expectation maximisation (EM), hierarchical clustering, perceptron back-propagation, hopfield network, radial basis function network (RBFN), deep boltzmann machine (DBM), deep belief networks (DBN), convolutional neural network (CNN), stacked auto-encoders, principal component regression (PCR), partial least squares regression (PLSR), sammon mapping, multidimensional scaling (MDS), projection pursuit, linear discriminant analysis (LDA), mixture discriminant analysis (MDA), quadratic discriminant analysis (QDA), flexible discriminant analysis (FDA), bootstrapped aggregation (bagging), adaboost, stacked generalization (blending), gradient boosting machines (GBM), gradient boosted regression trees (GBRT), random forest, or even algorithms yet to be invented.

In a preferred embodiment, the system 400 may determine training content to be presented to one or more candidates within the user interface 411 using a machine learning technique that analyzes candidate interactions with test samples presented through the test module 430B. For instance, the system 400 may obtain test data 425C from a candidate and process it using pattern recognition algorithms to discern if a candidate is struggling with flaw detection techniques, subsequently presenting additional training materials within the user interface 411 that correspond to flaw identification exercises. The system 400 may then present training data 425B to the candidate pertaining to the specific NDT technique the candidate requires improvement in, wherein the training data 425B is displayed within the user interface 411 alongside augmented reality overlays that enable the candidate to visualize proper testing procedures. In a preferred embodiment, training content presented to a candidate is based on user data 425A and test data 425C contained within the user profile 425 of the candidate, and the test module 430B dynamically generates test samples within the user interface 411 that correspond to the candidate's identified areas of weakness. In some preferred embodiments, the system 400 may use machine learning techniques to create training groups for a plurality of candidates using the administrator module 430A, wherein the system 400 presents test samples within the test module 430B that address the common deficiencies of the plurality of candidates. For instance, if the system 400 determines, by way of semi-supervised learning, that at least two candidates participating in the same training group have different strengths in flaw detection but similar weaknesses in thickness measurement accuracy, the system 400 may create a training pathway that emphasizes thickness measurement exercises and presents test samples within the test module 430B that enable candidates to practice those shared areas requiring improvement.

In another preferred embodiment, the system 400 may determine, through use of decision tree supervised learning, that at least one candidate participating in the remote NDT training program is a novice with limited prior experience, and the system 400 may adjust the presentation of test samples within the test module 430B to provide foundational training exercises before advancing to more complex flaw detection scenarios. In some preferred embodiments, the system 400 may take into account what certification level the candidate is pursuing before creating and presenting a training pathway within the user interface 411. For instance, if a candidate is using the system 400 to prepare for ASNT ISQ-UTT certification within the test module 430B, the system 400 may choose to present within the user interface 411 at least one test sample of a training pathway that pertains to ultrasonic thickness testing techniques, along with augmented reality overlays through the live viewer module 430E that enable the candidate to visualize proper transducer placement and measurement procedures. As illustrated in FIG. 10, the test module 430B may present sample data showing performance metrics within the user interface 411, wherein the system 400 generates test samples that correspond to specific competency areas that the candidate may practice to improve their certification readiness. The AI techniques integrated within the system 400 may analyze the test results being displayed within the test viewer module 430C and proactively suggest training exercises within the user interface 411 that correspond to related NDT techniques, sample types, or measurement procedures. For example, when a candidate is reviewing test results showing low accuracy in minimum thickness measurements within the test viewer module 430C, the AI techniques may cause the system 400 to present additional calibration training exercises and measurement technique demonstrations through the live viewer module 430E that enable the candidate to improve their proficiency in that specific area of NDT practice.

In a preferred embodiment, the system 400 may use more than one machine learning technique to determine which training content may be most beneficial to a candidate based on their user data 425A within their user profile 425, and the test module 430B may dynamically update the test samples presented within the user interface 411 based on the machine learning analysis. For instance, a system 400 comprising a microphone operably connected to the computing entity 200 may use a combination of NLP and reinforcement learning to discern which NDT techniques a candidate finds more challenging and which testing methods a candidate has verbally expressed difficulty with, subsequently presenting test samples within the user interface 411 that correspond to those areas requiring improvement. If the system 400 determines that a candidate is showing proficiency in a particular testing technique presented within the test module 430B, the system 400 may create a new training pathway using test samples that the system 400 has determined the candidate requires additional practice with, and the test module 430B may update the test samples within the user interface 411 accordingly. In another preferred embodiment, the system 400 may actively monitor candidates' performance on tests displayed within the user interface 411 and change the training focus if it is determined the candidate has mastered certain competencies, presenting new test samples that correspond to alternative NDT techniques or more advanced certification requirements. For instance, the system 400 comprising a camera 407 may use a combination of facial emotion recognition and deep learning to discern engagement of a candidate during a training session and adjust the training content within the live viewer module 430E if it is determined that the candidate is struggling, simultaneously updating the test samples within the test module 430B to reflect the identified areas of difficulty. As illustrated in FIG. 4, the camera 407 operably connected to the computing entity 200 may capture candidate reactions that the AI techniques analyze to refine the presentation of training content within the user interface 411.

In a preferred embodiment, the machine learning techniques comprise instructions configured to create trained machine learning techniques from at least some training data and according to an implementation of the machine learning techniques, wherein the training data serves as a baseline dataset that may act as the foundational data of the machine learning techniques. The instructions of the machine learning techniques dictate how the machine learning techniques gain knowledge from the various data sources of the system and may comprise various types of programmable instructions that include, but are not limited to, local commands, remote commands, executable files, protocol commands, selected commands, or any combination thereof. The instructions of the machine learning techniques may vary widely, depending on a desired implementation. In a preferred embodiment, instructions may include streamlined instructions that instruct the machine learning techniques on how to train the system, possibly in the form of a script (e.g., Python, Ruby, JavaScript, etc.). In another preferred embodiment, the instructions may include data filters or data selection criteria that define requirements for desired results sets created from the various data of the system as well as which machine learning algorithm is to be used.

Training of the machine learning techniques may be supervised, semi-supervised, or unsupervised, wherein the training process enables the system 400 to optimize the presentation of test samples within the test module 430B of the user interface 411. In some preferred embodiments, the machine learning systems may use NLP to analyze data including audio data and text data to determine candidate learning patterns and competency gaps that inform the dynamic generation of training pathways within the system 400. For instance, the system 400 may use audio data captured from a candidate during live training sessions to determine areas of difficulty for the candidate, and the test module 430B may subsequently present test samples within the user interface 411 that correspond to NDT techniques and certification requirements aligned with those identified weaknesses. The user data 425A pertaining to a candidate's performance history may be used to train the machine learning technique as to what kinds of competencies a candidate has developed and what types of test samples should be presented within the test module 430B alongside corresponding training materials that enable skill development. Training of the machine learning techniques may result in baseline machine learning techniques that may serve as AI techniques for performing the various functions of the system 400 in the manners described herein, including the dynamic generation and sequencing of test samples within the test module 430B. Baseline machine learning techniques may further be configured to act as passive models or active models, wherein each model type influences how the test module 430B presents test samples within the user interface 411 based on user data 425A and performance factors.

In a preferred embodiment, a passive model may be described as a final, completed machine learning model that uses only the baseline data set to establish behavior of the baseline machine learning technique for presenting test samples within the test module 430B of the user interface 411. An active model may be described as a plasticity machine learning model that is dynamic in that it may be updated using both the baseline dataset and data outside of the baseline data set, enabling the test module 430B to refine the test samples presented within the user interface 411 based on ongoing candidate performance. The system 400 may use a passive model to allow for a high degree of control as to how the system 400 manages training pathways and test samples in the manners described herein, wherein the test samples presented within the test module 430B remain consistent across candidates regardless of individual performance levels. For instance, a passive model may be configured via a standardized dataset to provide each candidate of the system 400 with the same test samples within the test module 430B and the same training materials within the user interface 411 for developing competencies such as ultrasonic thickness testing, flaw detection, and measurement accuracy. As illustrated in FIG. 5, the system module 430 may present the administrator module 430A, test module 430B, test viewer module 430C, sample manager module 430D, and live viewer module 430E within the user interface 411, wherein a passive model ensures that these modules are presented consistently to all candidates regardless of their individual user data 425A. A passive model may be especially useful for candidates having user profiles 425 with little test data 425C from which the machine learning techniques may learn, ensuring that new candidates receive a functional and complete set of test samples within the test module 430B from their initial interaction with the system 400.

In some preferred embodiments, the system 400 may be configured to begin as passive models until a threshold amount of test data 425C has been acquired, after which the test module 430B may transition to presenting test samples within the user interface 411 based on active model recommendations. Once the threshold amount of test data 425C has been acquired, the system 400 may cause the machine learning techniques to switch to active models, allowing the system 400 to make recommendations to a candidate that better parallel historical performance patterns of the candidate and present test samples within the test module 430B that correspond to NDT techniques and certification requirements the candidate is likely to benefit from practicing. For instance, a system 400 may be configured to present certain standardized test samples within the test module 430B and standard training materials within the user interface 411 via a passive machine model until at least one month worth of test data 425C pertaining to performance of a candidate has been collected. As illustrated in FIG. 10, once the preset amount of data has been collected, the machine learning techniques of the system 400 may switch to an active machine model for that particular candidate and present personalized test samples within the test module 430B such as focused exercises for flaw detection accuracy or minimum thickness measurement precision based on the candidate's demonstrated weaknesses. In another preferred embodiment, the AI techniques integrated within the system 400 may analyze the transition from passive to active models and proactively inform the candidate that personalized training pathways are now available within the user interface 411 based on their accumulated performance history. The test module 430B coordinates the transition between passive and active models to ensure seamless presentation of test samples within the user interface 411 without disrupting the candidate's ongoing interaction with the system 400.

In a preferred embodiment, an active machine model may be updated in real-time, daily, weekly, bimonthly, monthly, quarterly, or annually using the various data of the system 400, enabling the test module 430B to present increasingly relevant test samples within the user interface 411 as candidate competencies evolve. The data used to update the active machine model may include model instructions, shifts in time, new or corrected training datasets, user data 425A, test data 425C, and interaction patterns with test samples within the test module 430B. In some preferred embodiments, the passive machine model may also be updated as new or updated training datasets become available, ensuring that the baseline test samples presented within the test module 430B reflect current NDT certification requirements and industry standards established by organizations such as ASNT. As illustrated in FIG. 4, the processor 220 operably connected to the database 115 and non-transitory computer-readable medium 416 facilitates the storage and retrieval of model update data that informs the presentation of test samples within the user interface 411. In another preferred embodiment, machine learning techniques comprise metadata that describe the state of the passive or active model with respect to its updates, wherein the metadata may include attributes describing a version number, date updated, amount of new data used for the update, shifts in model parameters, convergence requirements, or other information relevant to the generation of test samples within the test module 430B. Because each candidate of the system 400 may potentially have a unique machine learning technique associated with their user profile 425 due to the personal nature of test data 425C associated with each user profile 425, such information allows for identifying distinct passive or active models within the system 400 that may be separately managed to ensure that test samples presented within the test module 430B are appropriately tailored to each candidate.

To prevent an un-authorized user 405 from accessing information of other user’s 405, the system 400 may employ a security method. As illustrated in FIG. 13, the security method of the system 400 may comprise a plurality of permission levels 1300 that may grant users 405 access to user content 1315, 1335, 1355 within the database 115 while simultaneously denying users 405 without appropriate permission levels 1300 the ability to view user content 1315, 1335, 1355. In some embodiments, the permission levels 1300 limit access for users such that a user may only edit the user's own candidate information, e.g., if the user is a candidate, or a select group of candidates' information, e.g., if the user is a trainer with a set number of candidates they are training via the system. To access the user content 1315, 1335, 1355 stored within the database 115, users 405 may be required to make a request via a user interface. Access to the data within the database 115 may be granted or denied by the processor 220 based on verification of a requesting user’s 1305, 1325, 1345 permission level 1300. If the requesting user’s 1305, 1325, 1345 permission level 1300 is sufficient, the processor 220 may provide the requesting user 1305, 1325, 1345 access to user content 1315, 1335, 1355 stored within the database 115. Conversely, if the requesting user’s 1305, 1325, 1345 permission level 1300 is insufficient, the processor 220 may deny the requesting user 1305, 1325, 1345 access to user content 1315, 1335, 1355 stored within the database 115. In an embodiment, permission levels 1300 may be based on user roles 1310, 1330, 1350 and administrator roles 1370, as illustrated in FIG. 13. User roles 1310, 1330, 1350 allow requesting users 1305, 1325, 1345 to access user content 1315, 1335, 1355 that a user 405 has uploaded and/or otherwise obtained through use of the system 400. Administrator roles 1370 allow administrators 1365 to access system 400 wide data.

In an embodiment, user roles 1310, 1330, 1350 may be assigned to a user in a way such that a requesting user 1305, 1325, 1345 may view user profiles 425 containing user data 425A, patient data 425B, and image data 425C via a user interface. To access the data within the database 115, a user 405 may make a user request via the user interface to the processor 220. In an embodiment, the processor 220 may grant or deny the request based on the permission level 1300 associated with the requesting user 1305, 1325, 1345. Only users 405 having appropriate user roles 1310, 1330, 1350 or administrator roles 1370 may access the data within the user profiles 425. For instance, as illustrated in FIG. 13, requesting user 11305 has permission to view user 1 content 1315 and user 2 content 1335 whereas requesting user 21325 only has permission to view user 2 content 1335. Alternatively, user content 1315, 1335, 1355 may be restricted in a way such that a user may only view a limited amount of user content 1315, 1335, 1355. For instance, requesting user 31345 may be granted a permission level 1300 that only allows them to view user 3 content 1355 related to training but not user 3 content 1355 related to testing. As illustrated in FIG. 13, an administrator 1365 may bestow a new permission level 1300 on users 405 so that they may grant the users 405 greater permissions or lesser permissions. For instance, an administrator 1365 may bestow a greater permission level 1300 on other users 405 so that they may view user 3’s content 1355 and/or any other user’s 405 content 1315, 1335, 1355. Therefore, the permission levels 1300 of the system 400 may be assigned to users 405 in various ways without departing from the inventive subject matter described herein.

FIG. 14 provides a flow chart 1400 illustrating certain preferred method steps that may be used to carry out the method of remote non-destructive testing training and certification in accordance with an embodiment of the present invention. In a preferred embodiment, the system 400 begins at step 1405 where a user 405 initiates a connection to the at least one server 110 through a network 150 using a client device 105 such as a computing device 300 or mobile computing device 350. As illustrated in FIG. 4, the server 110 is operably connected to the database 115 and processor 220, enabling the system 400 to process user requests and manage data storage throughout the training and certification workflow. The initial connection step 1405 establishes a secure communication pathway between the user's client device 105 and the server 110, preparing the system 400 for subsequent authentication and training operations. In some preferred embodiments, the connection may be established through various network protocols including wireless connections via the communication interface 280 or wired connections through the external interface 362. The connection step 1405 serves as the entry point for all subsequent method steps.

In another preferred embodiment, upon accessing the at least one server 110 at step 1405, the system 400 proceeds to step 1410 where the system 400 presents a log-in interface through the user interface 411 to the user 405. The log-in interface displayed at step 1410 provides the user 405 with options to either register as a new participant in the remote non-destructive testing training platform or log-in using previously established account credentials. As illustrated in FIG. 4, the user interface 411 connects to the computing entity 200 and processor 220, enabling the system 400 to process authentication requests and verify user credentials against stored user data 425A within the database 115. For new users, the registration process at step 1410 collects candidate information including first name, last name, username, email address, password, and company affiliation as depicted in the administrator module 430A interface shown in FIG. 8. In some preferred embodiments, the log-in interface may include additional security features such as two-factor authentication or biometric verification to enhance account protection. The authentication step 1410 ensures that only authorized users 405 may proceed to access the training and testing functionality of the system 400.

In a preferred embodiment, following successful authentication at step 1410, the system 400 proceeds to step 1415 where the system 400 displays a selection screen through the user interface 411 presenting the available system modules 430 to the user 405. As illustrated in FIG. 5, the selection screen at step 1415 provides access to the administrator module 430A, test module 430B, test viewer module 430C, sample manager module 430D, and live viewer module 430E based on the permission levels 1300 associated with the logged-in user 405. The selection screen enables users 405 to navigate to their desired functionality within the remote non-destructive testing training platform by selecting the appropriate module icon or menu item. For instance, a candidate may select the test module 430B to begin a practice examination, while a trainer may select the sample manager module 430D to update testing materials. In another preferred embodiment, the selection screen at step 1415 may display personalized information such as pending tests, upcoming training sessions, or recent performance summaries based on data retrieved from the user profile 425 stored in the database 115. The selection screen step 1415 serves as the central navigation hub from which users 405 access all training and certification functionality provided by the system 400.

In some preferred embodiments, when a new candidate registers with the system 400, the system 400 proceeds to step 1420 where the administrator module 430A processes the received candidate information to generate a unique Candidate ID for the newly registered user 405. As illustrated in FIG. 8, the administrator module 430A receives candidate information including name, phone number, email address, and company affiliation, and applies an identification algorithm to create a distinctive alphanumeric identifier. For example, the Candidate ID generation at step 1420 may combine the first two letters of the candidate's name with a portion of their phone number to create a unique identifier such as "JO5551234" for a candidate named John with phone number 555-123-4567. The generated Candidate ID is stored within the user data 425A of the candidate's user profile 425 in the database 115 for subsequent reference throughout the training and certification process. In another preferred embodiment, the Candidate ID generation step 1420 may include validation checks to ensure that the generated identifier does not conflict with existing Candidate IDs stored within the database 115. The unique Candidate ID created at step 1420 enables the system 400 to accurately track individual candidate progress and maintain organized records of all training activities.

In a preferred embodiment, following Candidate ID generation at step 1420, the system 400 proceeds to step 1425 where the test module 430B uses the Candidate ID to generate a testing profile for each candidate participating in the remote non-destructive testing training program. As illustrated in FIG. 4, the testing profile is stored within the user profile 425 and maintains associations between the candidate's Candidate ID, their training data 425B, and their test data 425C within the database 115. The testing profile generation at step 1425 establishes the data structures necessary for tracking candidate progress, storing test results, and maintaining certification records throughout the training process. For instance, a testing profile for a candidate preparing for ASNT ISQ-UTT certification would be configured to track ultrasonic thickness testing competencies, flaw detection accuracy, and measurement precision scores. In some preferred embodiments, the testing profile may include customizable parameters that allow trainers to assign specific training pathways or competency requirements based on individual candidate needs. The testing profile created at step 1425 serves as the foundation for all subsequent testing and training activities conducted through the test module 430B.

In another preferred embodiment, the system 400 proceeds to step 1430 where the test module 430B provides each candidate with the ability to take tests that prepare them for NDT certification examinations using test samples managed through the sample manager module 430D. As illustrated in FIG. 10, the test module 430B presents candidates with sample data including flaw type identification, minimum thickness measurements, and maximum thickness measurements that simulate real-world non-destructive testing scenarios. The candidate interacts with the test interface at step 1430 by inputting their analysis results, measurement values, and flaw identification conclusions based on their examination of the presented test samples. For example, a candidate may be presented with an ultrasonic thickness testing sample requiring identification of the flaw type as either "M" (metal loss) or "W" (weld defect) along with corresponding minimum and maximum thickness values as shown in FIG. 11. In some preferred embodiments, the test interface at step 1430 may include timer functionality, reference material access, or interactive sample visualization features that enhance the testing experience. The testing step 1430 enables candidates to develop and demonstrate their proficiency in NDT techniques through practical application exercises.

In a preferred embodiment, after the candidate completes their test inputs at step 1430, the system 400 proceeds to step 1435 where the candidate selects a submit button within the user interface 411 to transmit their test answers to the test module 430B for evaluation. As illustrated in FIG. 12, the test module 430B receives the submitted test inputs including flaw designations, minimum answer values, and maximum answer values for each analyzed sample. The submission step 1435 triggers the processor 220 to initiate the automated grading algorithms that compare candidate responses against the actual sample parameters stored within the database 115. In some preferred embodiments, the submission step 1435 may include confirmation prompts that allow candidates to review their answers before final submission to prevent accidental incomplete submissions. The test module 430B records the submission timestamp and associates the submitted test data with the candidate's testing profile for subsequent analysis and archival. The submission step 1435 marks the transition from active testing to automated evaluation.

In another preferred embodiment, following submission at step 1435, the system 400 proceeds to step 1440 where the test module 430B automatically grades the candidate's test answers by comparing submitted values against known sample parameters and acceptable deviation tolerances. As illustrated in FIG. 12, the grading process at step 1440 evaluates each submitted answer against actual minimum values, actual maximum values, and corresponding deviation ranges to determine measurement accuracy. The test module 430B calculates performance metrics including flaw correct percentage, minimum dimension correct percentage, maximum dimension correct percentage, and overall passing percentage as depicted in FIG. 6. For instance, if a candidate submits a minimum thickness value of 0.245 inches for a sample with an actual minimum of 0.250 inches and an acceptable deviation of plus or minus 0.010 inches, the test module 430B determines that the answer falls within acceptable tolerances and marks it as correct. In some preferred embodiments, the grading algorithms at step 1440 may apply weighted scoring that emphasizes certain competency areas based on certification requirements established by organizations such as ASNT. The automated grading step 1440 provides immediate feedback to candidates regarding their performance on the submitted test.

In a preferred embodiment, following grading at step 1440, the system 400 proceeds to step 1445 where the test module 430B archives the test grade, test inputs, and test sample information within the test data 425C of the candidate's user profile 425 stored in the database 115. As illustrated in FIG. 4, the archival step 1445 ensures that all testing activities are permanently recorded and associated with the appropriate Candidate ID for subsequent review by both the candidate and their assigned trainer. The archived data at step 1445 includes detailed records of each submitted answer, the corresponding correct values, deviation calculations, and overall performance scores that document the candidate's proficiency development. In some preferred embodiments, the archival process at step 1445 may include metadata such as test duration, number of attempts, and comparative performance rankings that provide additional context for training assessment. The test viewer module 430C, as illustrated in FIG. 7, enables authorized users to access archived test data through the review functionality described in step 1450. The archival step 1445 supports long-term tracking of candidate progress and provides evidence of training completion for certification documentation purposes.

In another preferred embodiment, the system 400 proceeds to step 1450 where the test viewer module 430C provides candidates and trainers with the ability to review archived tests and training feedback stored within the database 115. As illustrated in FIG. 6 and FIG. 7, the test viewer module 430C displays performance metrics, individual test results, and historical progress data that enable users to assess candidate development over time. The review functionality at step 1450 allows candidates to identify areas requiring additional practice by examining their performance patterns across multiple testing sessions. For instance, a candidate may use the test viewer module 430C at step 1450 to review tests where they scored below passing thresholds in minimum thickness measurements, enabling focused remediation efforts. In some preferred embodiments, the review step 1450 may include PDF document generation functionality that allows users to create permanent records of test results for certification documentation or employer reporting purposes. The review step 1450 completes the testing cycle within the system 400 and may loop back to step 1430 for additional testing or proceed to step 1455 for live training sessions conducted through the live viewer module 430E.

The subject matter described herein may be embodied in systems, apparatuses, methods, and/or articles depending on the desired configuration. In particular, various implementations of the subject matter described herein may be realized in digital electronic circuitry, integrated circuitry, specially designed application specific integrated circuits (ASICs), computer hardware, firmware, software, and/or combinations thereof. These various implementations may include implementation in one or more computer programs that may be executable and/or interpretable on a programmable system including at least one programmable processor, which may be special or general purpose, coupled to receive data and instructions from, and to transmit data and instructions to, a storage system, and at least one peripheral device.

These computer programs, which may also be referred to as programs, software, applications, software applications, components, or code, may include machine instructions for a programmable processor, and may be implemented in a high-level procedural and/or object-oriented programming language, and/or in assembly machine language. As used herein, the term “non-transitory computer-readable medium” refers to any computer program, product, apparatus, and/or device, such as magnetic discs, optical disks, memory, and Programmable Logic Devices (PLDs), used to provide machine instructions and/or data to a programmable processor, including a non-transitory computer-readable medium that receives machine instructions as a computer-readable signal. The term “computer-readable signal” refers to any signal used to provide machine instructions and/or data to a programmable processor. To provide for interaction with a user, the subject matter described herein may be implemented on a computer having a display device, such as a cathode ray tube (CRD), liquid crystal display (LCD), light emitting display (LED) monitor for displaying information to the user and a keyboard and a pointing device, such as a mouse or a trackball, by which the user may provide input to the computer. Displays may include, but are not limited to, visual, auditory, cutaneous, kinesthetic, olfactory, and gustatory displays, or any combination thereof.

Other kinds of devices may be used to facilitate interaction with a user as well. For instance, feedback provided to the user may be any form of sensory feedback, such as visual feedback, auditory feedback, or tactile feedback; and input from the user may be received in any form including, but not limited to, acoustic, speech, or tactile input. The subject matter described herein may be implemented in a computing system that includes a back-end component, such as a data server, or that includes a middleware component, such as an application server, or that includes a front-end component, such as a client computer having a graphical user interface or a Web browser through which a user may interact with the system described herein, or any combination of such back-end, middleware, or front-end components. The components of the system may be interconnected by any form or medium of digital data communication, such as a communication network. Examples of communication networks may include, but are not limited to, a local area network (“LAN”), a wide area network (“WAN”), metropolitan area networks (“MAN”), and the internet.

The implementations set forth in the foregoing description do not represent all implementations consistent with the subject matter described herein. Instead, they are merely some examples consistent with aspects related to the described subject matter. Although a few variations have been described in detail above, other modifications or additions are possible.

In particular, further features and/or variations can be provided in addition to those set forth herein. For instance, the implementations described above can be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, devices, and arrangements of the parts and method stages which have been described and illustrated in order to explain the nature of this inventive subject matter can be made without departing from the principles and scope of the inventive subject matter.

What is claimed is:

1. A system for providing hands-on non-destructive testing training and testing, the system comprising:
at least one server having an internet connection and storing a plurality of instructions comprising an administrator module, a test module, a test viewer module, a sample manager module, and a live viewer module;
wherein the administrator module causes the system to receive, via the internet connection, candidate information, and generate a candidate ID based upon the candidate information;
wherein the test module causes the system to generate tests from a plurality of test samples, receive test input from a user, analyze the test input, and generate a test grade based upon the test input;
wherein the test viewer module causes the system to display selected groups of tests;
wherein the sample manager module causes the system to receive sample inputs and generate test samples based upon the sample inputs; and
wherein the live viewer module causes the system to receive video and audio inputs from a first user device and relay the video and audio inputs to a second user device, with the first and second user devices communicating via an internet connection that passes through the at least one server.

2. The system of claim 1, wherein the test module further causes the system to archive the test grade, test input, and test sample for subsequent review by the user.

3. The system of claim 1, wherein the candidate information includes at least a candidate name and a candidate phone number.

4. The system of claim 3, wherein the administrator module causes the system to generate the candidate ID based upon the candidate phone number and the first two letters of the candidate name.

5. The system of claim 1, wherein the live viewer module causes the system to generate and display an augmented reality overlay on at least the video inputs relayed to the second user device.

6. The system of claim 1, wherein the test module further causes the system to generate a testing profile tied to the candidate ID.

7. The system of claim 1, wherein the test viewer module causes the system to display performance metrics including flaw detection accuracy, minimum dimension accuracy, and maximum dimension accuracy.

8. The system of claim 1, wherein the sample manager module causes the system to update existing test samples based upon sample inputs received after initial generation of the test samples.

9. The system of claim 1, further comprising a database operably connected to the at least one server, wherein the database stores user profiles containing user data, training data, and test data.

10. The system of claim 1, wherein the test module causes the system to compare test inputs against known sample parameters and acceptable deviation tolerances to generate the test grade.

11. A method for providing non-destructive testing training, the method comprising the steps of:
receiving, via at least one server having an internet connection and comprising at least one processor executing a plurality of instructions within a memory, candidate information;
generating a candidate ID based upon the candidate information;
generating a testing profile tied to the candidate ID;
receiving test samples and test data, and storing the test samples and test data on the at least one server;
generating tests based upon the test samples and test data, and tying the tests to the testing profile;
receiving test inputs for at least one of the generated tests;
analyzing the test inputs;
generating a test grade based upon the test inputs;
archiving the test grade, test input, and test sample on the at least one server;
updating the test samples and test data based upon sample inputs received by the at least one server after initial reception of the test samples and test data; and
receiving video and audio inputs from a first user device, and displaying the video and audio inputs from the first user device on a user interface of a second user device.

12. The method of claim 11, further comprising the step of displaying at least one of a test grade, test input, and test sample upon user selection of a stored test grade, test input, and test sample, respectively.

13. The method of claim 11, wherein the candidate information includes at least a candidate name and a candidate phone number.

14. The method of claim 13, further comprising the step of generating the candidate ID based upon the candidate phone number and the first two letters of the candidate name.

15. The method of claim 11, further comprising the step of generating and displaying an augmented reality overlay on at least the video inputs displayed on the user interface of the second user device, such that oral and visual instruction of a first user of the first user device is provided to a second user of the second user device utilizing the augmented reality overlay.

16. The method of claim 11, wherein analyzing the test inputs comprises comparing the test inputs against known sample parameters and acceptable deviation tolerances.

17. The method of claim 11, further comprising the step of generating a PDF document containing the test grade and test inputs for the testing profile.

18. A non-transitory computer-readable medium storing instructions that, when executed by at least one processor, cause the at least one processor to:
receive, via an internet connection, candidate information;
generate a candidate ID based upon the candidate information;
generate a testing profile tied to the candidate ID;
receive test samples and test data, and store the test samples and test data;
generate tests based upon the test samples and test data;
receive test inputs for at least one of the generated tests;
analyze the test inputs by comparing the test inputs against known sample parameters;
generate a test grade based upon the test inputs;
archive the test grade, test input, and test sample; and
receive video and audio inputs from a first user device and relay the video and audio inputs to a second user device via the internet connection.

19. The non-transitory computer-readable medium of claim 18, wherein the instructions further cause the at least one processor to generate and display an augmented reality overlay on at least the video inputs relayed to the second user device.

20. The non-transitory computer-readable medium of claim 18, wherein the instructions further cause the at least one processor to update the test samples and test data based upon sample inputs received after initial reception of the test samples and test data.
